(19) United States
(12) Patent Application Publication
(10) Pub. No.: US 2015/0373075 A1
(43) Pub. Date: Dec. 24, 2015

(54) MULTIPLE NETWORK TRANSPORT SESSIONS TO PROVIDE CONTEXT ADAPTIVE VIDEO STREAMING

(71) Applicants: Radia Perlman, Redmond, WA (US); Vallabhajosyula S. Somayazulu, Portland, OR (US); Hassnaa Moustafa, Portland, OR (US); Jeffrey R. Foerster, Portland, OR (US); Zheng Lu, Austin, TX (US)

(72) Inventors: Radia Perlman, Redmond, WA (US); Vallabhajosyula S. Somayazulu, Portland, OR (US); Hassnaa Moustafa, Portland, OR (US); Jeffrey R. Foerster, Portland, OR (US); Zheng Lu, Austin, TX (US)

(21) Appl. No.: 14/311,698

(22) Filed: Jun. 23, 2014

(51) Int. Cl. H04L 29/06; H04L 29/08

(52) U.S. Cl. CPC H04L 65/608; H04L 67/02; H04L 69/16

(57) ABSTRACT

Methods, apparatus, systems, and software for implementing context adaptive video streaming using multiple streaming connections. Original video content is split into multiple bitstreams at a video streaming server and streamed to a video streaming client. Higher-importance video content, such as I-frames and the base layer for scalable video coder (SVC) content are streamed over a high-priority streaming connection, while lower-importance video content is streamed over a low-priority streaming connection. The high-priority streaming connection may employ a reliable connection protocol such as TCP protocol, while the lower-priority connection may employ UDP or a modified TCP protocol under which some portions of the bitstream may be dropped. Cross-layer context adaptive streaming may be implemented under which context data such as network context and video application context information may be considered to adjust parameters associated with implement one or more streaming connections.

### CROSS-REFERENCE TO RELATED APPLICATIONS

The present application contains subject matter related to U.S. application Ser. No. 14/041,446 entitled TRANSMISSION CONTROL PROTOCOL (TCP) BASED VIDEO STREAMING, filed Sep. 13, 2013. Both applications are subject to assignment to Intel Corporation.

### BACKGROUND INFORMATION

Video Streaming over wireless networks presents several challenges in providing the end-user with a good quality of experience (QoE) and optimizing the network resources utilization. Video is best played in real time in order to minimize the delay or lag, however pauses (for re-buffering) while playing have a negative effect on user QoE. In addition, some amount of data loss may be tolerable depending on the specific parts of the data stream which are lost (unequal error sensitivity or saliency of information). Video streaming should therefore exploit trade-offs among various user QoE parameters such as picture quality (loosely related to bitrate), latency, re-buffering delays and frame losses.

Modern video streaming protocols like HTTP (Hypertext Transport Protocol) progressive download and DASH (Dynamic Adaptive Streaming over HTTP) use TCP (Transmission Control Protocol) as the network transport. TCP has features that are not ideally matched to video transmission with good QoE as defined above. In particular, TCP delivers highly variable throughput and delay along with reliable, in-order delivery of all data. While this ensures (or at least attempts to ensure) all video content is successfully received, it impacts the quality of ‘smoothness’ and latency of video delivery negatively.

There have been a number of solutions previously proposed to improve the performance of TCP over wireless networks, and for optimization of video quality over TCP. One issue with these previous solutions is that they require changes in the network transport protocol, or the implementations in the client and server of the video stream. The most convenient way to deploy an application is as a user-level process, which means using the Operating system's unmodified TCP or UDP (User Datagram Protocol) over IP (Internet Protocol).

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein like reference numerals refer to like parts throughout the various views unless otherwise specified:

FIG. 1 is a diagram illustrating an encoding order and playback order of a sequence of I-frames, P-frames, and B-frames;

FIG. 2 is a schematic diagram of a system architecture used for transferring video content from a video streaming server to a video streaming client using a pair of streaming connections, according to an embodiment under which TCP is used for a high-priority streaming connection and UDP is used for a low-priority streaming connection;

FIG. 2a is a schematic diagram of a system architecture used for transferring video content from a video streaming server to a video streaming client using a pair of streaming connections, according to an embodiment under which TCP is used for a high-priority streaming connection and a modified TCP is used for a low-priority streaming connection;

FIG. 3 is a flowchart illustrating operations for performing streaming using multiple streams in accordance with the system architecture of FIG. 2;

FIG. 3a is a flowchart illustrating operations for performing streaming using multiple streams in accordance with the system architecture of FIG. 2a;

FIG. 4 is a diagram illustrating a system architecture for streaming scalable video coding content using multiple streams, according to one embodiment

FIG. 5a is a diagram illustrating sequence of TCP segments received at a TCP receiver under which a second TCP segment is missing;

FIGS. 5b-5d respectively depict three cases illustrating the delay (D) of TCP segments being forwarded to a decode pipeline in relation to the time threshold (Δ), which FIG. 5b shows a first Case 1 under which the D may be less than or equal to the time threshold (Δ); FIG. 5c shows a second Case 2 under which the D may be greater than the Δ, and FIG. 5d shows a third Case 3 under which the time threshold (Δ) may be zero;

FIG. 6 is a diagram illustrating a system for context adaptive transfer of TCP segments, according to one embodiment;

FIG. 7 is a flowchart illustrating operations performed by the system of FIG. 6 to selectively forward portion of a received bitstream with a missing TCP segment, accordingly to one embodiment;

FIG. 8 is a flowchart illustrating operations performed at a TCP receiver associated with a wireless device in response to detecting a missing TCP segment was not received;

FIG. 9 is a schematic diagram of a blade server node configured to implement aspects of the video streaming server embodiments described and illustrated herein; and

FIG. 10 is a schematic diagram of a mobile device configured to implement aspects of the video streaming client embodiments described and illustrated herein.

### DETAILED DESCRIPTION

Embodiments of methods, apparatus, systems, and software for implementing context adaptive video streaming using multiple streams are described herein. In the following description, numerous specific details are set forth to provide a thorough understanding of embodiments disclosed and illustrated herein. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

For clarity, individual components in the Figures herein may also be referred to by their labels in the Figures, rather than by a particular reference number. Additionally, reference numbers referring to a particular type of component (as opposed to a particular component) may be shown with a reference number followed by “(typ)” meaning “typical.” It will be understood that the configuration of these components will be typical of similar components that may exist but are not shown in the drawing Figures for simplicity and clarity or otherwise similar components that are not labeled with separate reference numbers. Conversely, “(typ)” is not to be construed as meaning the component, element, etc. is typically used for its disclosed function, implement, purpose, etc.

Under aspects of the embodiments disclosed herein, techniques are provided for implementing context adaptive video streaming over multiple streaming connections, resulting in enhanced QoE for streaming video viewers. To have a better understanding of how the embodiments may be implemented, a discussion of basic aspects of video compression and decompression techniques is first provided. In addition to the details herein, further details on how video compression and decompression may be implemented are available from a number of on-line sources, including in an EE Times.com article entitled “How video compression works,” available at http://www.eetimes.com/document.asp?doc_id=1275437, the source for much of the following discussion.

At a basic level, streaming video content is played-back on a display as a sequence of “frames” or “pictures.” Each frame, when rendered, comprises an array of pixels having dimensions corresponding to a playback resolution. For example, full HD (high-definition) video has a resolution of 1920 horizontal pixels by 1080 vertical pixels, which is commonly known as 1080p (progressive) or 1080i (interlaced). In turn, the frames are displayed at a frame rate, under which the frame's data is refreshed (re-rendered, as applicable) at the frame rate. For many years, standard definition (SD) television used a refresh rate of 30i (30 frames per second (fps) interlaced), which corresponded to updating two fields of interlaced video content every 1/30 seconds in an alternating manner. This produced the illusion of the frame rate being 60 frames per second. It is also noted that historically SD content was analog video, which uses raster scanning for display rather than pixels. The resolution of SD video on a digital display is 480 lines, noting that the analog signals used for decades actually had approximately 525 scan lines. As a result, DVD content has historically been encoded at 480i or 480p for the NTSC (National Television System Committee) markets, such as the United States.

Cable and satellite TV providers stream video content over optical and/or wired cable or through the atmosphere (long distance wireless). Terrestrial television broadcasts are likewise sent over the air; historically these were sent as analog signals, but since approximately 2010 all high-power TV broadcasters have been required to transmit using digital signals exclusively. Digital TV broadcast signals in the US generally include 480i, 480p, 720p 1280×720 pixel resolution), and 1080i.

Blu-ray Disc (BD) video content was introduced in 2003 in Japan and officially released in 2006. Blu-ray Discs support video playback at up to 1080p, which corresponds to 1920×1080 at 60 (59.94) fps. Although BDs support up to 60 fps, much of BD content (particularly recent BD content) is actually encoded at 24 fps progressive (also known as 1080/24p), which is the frame-rate that has historically been used for film (movies). Conversion to from 24 fps to 60 fps may typically be done using a 3:2 “pulldown” technique under which frame content is repeated in a 3:2 pattern, which may create various types of video artifacts, particularly when playing back content with a lot of motion. Newer “smart” TV's have a refresh rate of 120 Hz or 240 Hz, each of which is an even multiple of 24. As a result, these TVs support a 24 fps “Movie” or “Cinema” mode under which they digital video content using an HDMI (High Definition Multimedia interface) digital video signal, and the extracted frame content is repeated using a 5:5 or 10:10 pulldown to display the 24 fps content at 120 fps or 240 fps to match the refresh rate of the TVs. More recently, smart TVs from manufacturers such as Sony and Samsung support playback modes under which multiple interpolated frames are created between the actual 24 fps frames to create a smoothing effect.

Compliant Blu-ray Disc playback devices are required to support three video encoding standards: H.262/MPEG-2 Part 2, H.264/MPEG-4 AVC, and VC-1. Each of these video encoding standards operates in a similar manner described below, noting there are some variances between these standards.

In addition to video content being encoded on DVDs and Blu-ray Discs, a massive amount of video content is delivered using video streaming techniques. The encoding techniques used for streaming media such as movies generally may be identical or similar to that used for BD content. For example, each of Netflix and Amazon Instant Video use VC-1, which was initially developed as a proprietary video format by Microsoft, and was released as a SMPTE (Society of Motion Picture and Television Engineers) video codec standard in 2006. Meanwhile, YouTube uses a mixture of video encoding standards that are generally the same as used to record the uploaded video content, most of which is recorded using consumer-level video recording equipment (e.g., camcorders and digital cameras), as opposed to professional-level equipment used to record original television content and some resent movies.

To provide an example of how much video content is being streamed, recent measurements indicate that during peak consumption periods Netflix streaming was using one-third of the bandwidth of Comcast's cable Internet services. In addition to supporting full HD (1080p) streaming since 2011, Netflix has been experimenting with streaming delivery of 4K video (3840×2160). Many leaders in the video industry foresee 4K video as the next HD standard (currently referred to Ultra-High Definition or UHD).

The more-advanced Smart-TVs universally support playback of streaming media delivered via an IEEE 802.11-based wireless network (commonly referred to as WiFi™). Moreover, most of the newer BD players support WiFi™ streaming of video content, as does every smartphone. In addition, many recent smartphones and tablets support wireless video streaming schemes under which video can be viewed on a Smart TV via playback through the smartphone or table using WiFi™ Direct or wireless MHL (Mobile High-definition Link). Moreover, the data service bandwidths now available over LTE (Long-term Extension) mobile networks make such services as IPTV (Internet Protocol Television) a viable means for viewing television and other video content via a mobile network.

At a resolution of 1080, each frame comprises approximately 2.1 million pixels. Using only 8-bit pixel encoding would require a data streaming rate of nearly 17 million bits per second (mbps) to support a frame rate of only 1 frame per second if the video content was delivered as raw pixel data. Since this would be impractical, video content is encoded in a highly-compressed format.

Still images, such as viewed using an Internet browser, are typically encoded using JPEG (Joint Photographic Experts Group) or PNG (Portable Network Graphics) encoding. The original JPEG standard defines a “lossy” compression scheme under which the pixels in the decoded image may differ from the original image. In contrast, PNG employs a “lossless” compression scheme. Since lossless video would have been impractical on many levels, the various video compression standards bodies such as the Motion Photographic Expert Group (MPEG) that defined the first MPEG-1 compression standard (1993) employ lossy compression techniques including still-image encoding of intra-frames (“I-frames”) (also known as “key” frames) in combination with motion prediction techniques used to generate other types of frames such as prediction frames (“P-frames”) and bi-directional frames (“B-frames”).

Since digitized video content is made up of a sequence of frames, video compression algorithms employ concepts and techniques employed in still-image compression. Still-image compression employs a combination of block-encoding and advanced mathematics to substantially reduce the number of bits employed for encoding the image. For example, JPEG divides an image into 8×8 pixel blocks, and transforms each block into a frequency-domain representation using a discrete cosine transformation (DCT). Generally, other block sizes besides 8×8 and algorithms besides DCT may be employed for the block transform operation for other standard-based and propriety compression schemes.

The DCT transform is used to facilitate frequency-based compression techniques. A person's visual perception is more sensitive to the information contained in low frequencies (corresponding to large features in the image) than to the information contained in high frequencies (corresponding to small features). The DCT helps separate the more perceptually-significant information from less-perceptually significant information.

After block transform, the transform coefficients for each block are compressed using quantization and coding. Quantization reduces the precision of the transform coefficients in a biased manner: more bits are used for low-frequency coefficients and fewer bits for high-frequency coefficients. This takes advantage of the fact, as noted above, that human vision is more sensitive to low-frequency information, so the high-frequency information can be more approximate.

Next, the number of bits used to represent the quantized DCT coefficients is reduced by “coding,” which takes advantage of some of the statistical properties of the coefficients. After quantization, many of the DCT coefficients—often, the vast majority of the high-frequency coefficients—are zero. A technique called “run-length coding” (RLC) takes advantage of this fact by grouping consecutive zero-valued coefficients (a “run”) and encoding the number of coefficients (the “length”) instead of encoding the individual zero-valued coefficients.

Run-length coding is typically followed by variable-length coding (VLC). In variable-length coding, commonly occurring symbols (representing quantized DCT coefficients or runs of zero-valued quantized coefficients) are represented using code words that contain only a few bits, while less common symbols are represented with longer code words. By using fewer bits for the most common symbols, VLC reduces the average number of bits required to encode a symbol thereby reducing the number of bits required to encode the entire image.

At this stage, all of the foregoing techniques operate on each 8×8 block independently from any other block. Since images typically contain features that are much larger than an 8×8 block, more efficient compression can be achieved by taking into account the similarities between adjacent blocks in the image. To take advantage of such inter-block similarities, a prediction step is often added prior to quantization of the transform coefficients. In this step, codecs attempt to predict the image information within a block using the information from the surrounding blocks. Some codecs (such as MPEG-4) perform this step in the frequency domain, by predicting DCT coefficients. Other codecs (such as H.264/AVC) do this step in the spatial domain, and predict pixels directly. The latter approach is called “intra prediction.”

In this operation, the encoder attempts to predict the values of some of the DCT coefficients (if done in the frequency domain) or pixel values (if done in the spatial domain) in each block based on the coefficients or pixels in the surrounding blocks. The encoder then computes the difference between the actual value and the predicted value and encodes the difference rather than the actual value. At the decoder, the coefficients are reconstructed by performing the same prediction and then adding the difference transmitted by the encoder. Because the difference tends to be small compared to the actual coefficient values, this technique reduces the number of bits required to represent the DCT coefficients.

In predicting the DCT coefficient or pixel values of a particular block, the decoder has access only to the values of surrounding blocks that have already been decoded. Therefore, the encoder must predict the DCT coefficients or pixel values of each block based only on the values from previously encoded surrounding blocks. JPEG uses a very rudimentary DCT coefficient prediction scheme, in which only the lowest-frequency coefficient (the “DC coefficient”) is predicted using simple differential coding. MPEG-4 video uses a more sophisticated scheme that attempts to predict the first DCT coefficient in each row and each column of the 8×8 block.

In contrast to MPEG-4, in H.264/AVC the prediction is done on pixels directly, and the DCT-like integer transform always processes a residual—either from motion estimation or from intra-prediction. In H.264/AVC, the pixel values are never transformed directly as they are in JPEG or MPEG-4 I-frames. As a result, the decoder has to decode the transform coefficients and perform the inverse transform in order to obtain the residual, which is added to the predicted pixels.

Color images are typically represented using several “color planes.” For example, an RGB color image contains a red color plane, a green color plane, and a blue color plane. When overlaid and mixed, the three planes make up the full color image. To compress a color image, the still-image compression techniques described earlier can be applied to each color plane in turn.

Imaging and video applications often use a color scheme in which the color planes do not correspond to specific colors. Instead, one color plane contains luminance information (the overall brightness of each pixel in the color image) and two more color planes contain color (chrominance) information that when combined with luminance can be used to derive the specific levels of the red, green, and blue components of each image pixel. Such a color scheme is convenient because the human eye is more sensitive to luminance than to color, so the chrominance planes can often be stored and/or encoded at a lower image resolution than the luminance information. In many video compression algorithms the chrominance planes are encoded with half the horizontal resolution and half the vertical resolution of the luminance plane. Thus, for every 16-pixel by 16-pixel region in the luminance plane, each chrominance plane contains one 8-pixel by 8-pixel block. In typical video compression algorithms, a “macro block” is a 16×16 region in the video frame that contains four 8×8 luminance blocks and the two corresponding 8×8 chrominance blocks.

While video and still-image compression algorithms share many compression techniques, a key difference is how motion is handled. One extreme approach would be to encode each frame using JPEG, or a similar still-image compression algorithm, and then decode the JPEG frames to generate at the player. JPEGs and similar still-image compression algorithms can produce good quality images at compression ratios of about 10:1, while advanced compression algorithms may produce similar quality at compression ratios as high as 30:1. While 10:1 and 30:1 are substantial compression ratios, video compression algorithms can provide good quality video at compression ratios up to approximately 200:1. This is accomplished through use of video-specific compression techniques such as motion estimation and motion compensation in combination with still-image compression techniques.

For each macro block in the current frame, motion estimation attempts to find a region in a previously encoded frame (called a “reference frame”) that is a close match. The spatial offset between the current block and selected block from the reference frame is called a “motion vector.” The encoder computes the pixel-by-pixel difference between the selected block from the reference frame and the current block and transmits this “prediction error” along with the motion vector. Most video compression standards allow motion-based prediction to be bypassed if the encoder fails to find a good match for the macro block. In this case, the macro block itself is encoded instead of the prediction error.

It is noted that the reference frame isn't always the immediately-preceding frame in the sequence of displayed video frames. Rather, video compression algorithms commonly encode frames in a different order from the order in which they are displayed. The encoder may skip several frames ahead and encode a future video frame, then skip backward and encode the next frame in the display sequence. This is done so that motion estimation can be performed backward in time, using the encoded future frame as a reference frame. Video compression algorithms also commonly allow the use of two reference frames—one previously displayed frame and one previously encoded future frame.

Video compression algorithms periodically encode intra-frames using still-image coding techniques only, without relying on previously encoded frames. If a frame in the compressed bit stream is corrupted by errors (e.g., due to dropped packets or other transport errors), the video decoder can “restart” at the next I-frame, which doesn't require a reference frame for reconstruction.

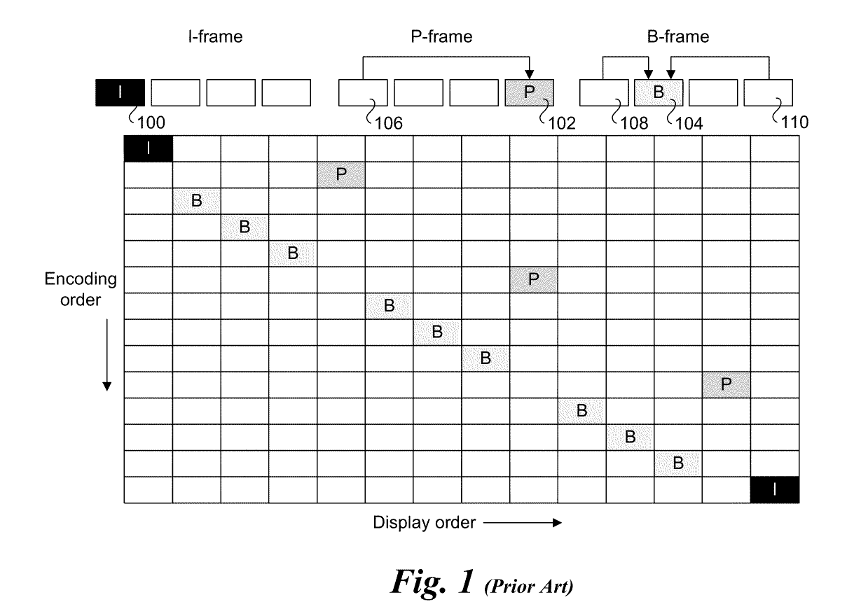

FIG. 1 shows an exemplary frame encoding and display scheme consisting of I-frames 100, P-frames 102, and B-frames 104. As discussed above, I-frames are periodically encoded in a manner similar to still images and are not dependent on other frames. P-frames (Predicted-frames) are encoded using only a previously displayed reference frame, as depicted by a previous frame 106. Meanwhile, B-frames (Bi-directional frames) are encoded using both future and previously displayed reference frames, as depicted by a previous frame 108 and a future frame 110.

The lower portion of FIG. 1 depicts an exemplary frame encoding sequence (progressing downward) and a corresponding display playback order (progressing toward the right). In this example, each P-frames is followed by three B-frames in the encoding order. Meanwhile, in the display order, each P-frame is displayed after three B-frames, demonstrating that the encoding order and display order are not the same. In addition it is noted that the occurrence of P-frames and B-frames will generally vary, depending on how much motion is present in the captured video; the use of one P-frame followed by three B-frames herein is for simplicity and ease of understanding how I-frames, P-frames, and B-frames are implemented.

One factor that complicates motion estimation is that the displacement of an object from the reference frame to the current frame may be a non-integer number of pixels. To handle such situations, modern video compression standards allow motion vectors to have non-integer values, resulting, for example, in motion vector resolutions of one-half or one-quarter of a pixel. To support searching for block matches at partial-pixel displacements, the encoder employs interpolation to estimate the reference frame's pixel values at non-integer locations.

Due, in part, to processor limitations, motion estimation algorithms use various methods to select a limited number of promising candidate motion vectors (roughly 10 to 100 vectors in most cases) and evaluate only the 16×16 regions corresponding to these candidate vectors. One approach is to select the candidate motion vectors in several stages, subsequently resulting in selection of the best motion vector. Another approach analyzes the motion vectors previously selected for surrounding macro blocks in the current and previous frames in an effort to predict the motion in the current macro block. A handful of candidate motion vectors are selected based on this analysis, and only these vectors are evaluated.

By selecting a small number of candidate vectors instead of scanning the search area exhaustively, the computational demand of motion estimation can be reduced considerably—sometimes by over two orders of magnitude. But there is a tradeoff between processing load and image quality or compression efficiency: in general, searching a larger number of candidate motion vectors allows the encoder to find a block in the reference frame that better matches each block in the current frame, thus reducing the prediction error. The lower the predication error, the fewer bits that are needed to encode the image. So increasing the number of candidate vectors allows a reduction in compressed bit rate, at the cost of performing more computations. Or, alternatively, increasing the number of candidate vectors while holding the compressed bit rate constant allows the prediction error to be encoded with higher precision, improving image quality.

Some codecs (including H.264) allow a 16×16 macroblock to be subdivided into smaller blocks (e.g., various combinations of 8×8, 4×8, 8×4, and 4×4 blocks) to lower the prediction error. Each of these smaller blocks can have its own motion vector. The motion estimation search for such a scheme begins by finding a good position for the entire 16×16 block. If the match is close enough, there's no need to subdivide further. But if the match is poor, then the algorithm starts at the best position found so far, and further subdivides the original block into 8×8 blocks. For each 8×8 block, the algorithm searches for the best position near the position selected by the 16×16 search. Depending on how quickly a good match is found, the algorithm can continue the process using smaller blocks of 8×4, 4×8, etc.

During playback, the video decoder performs motion compensation via use of the motion vectors encoded in the compressed bit stream to predict the pixels in each macro block. If the horizontal and vertical components of the motion vector are both integer values, then the predicted macro block is simply a copy of the 16-pixel by 16-pixel region of the reference frame. If either component of the motion vector has a non-integer value, interpolation is used to estimate the image at non-integer pixel locations. Next, the prediction error is decoded and added to the predicted macro block in order to reconstruct the actual macro block pixels. As mentioned earlier, for codecs such as H.264, the 16×16 macroblock may be subdivided into smaller sections with independent motion vectors.

Ideally, lossy image and video compression algorithms discard only perceptually insignificant information, so that to the human eye the reconstructed image or video sequence appears identical to the original uncompressed image or video. In practice, however, some artifacts may be visible, particularly in scenes with greater motion, such as when a scene is panned. This can happen due to a poor encoder implementation, video content that is particularly challenging to encode, or a selected bit rate that is too low for the video sequence, resolution, and frame rate. The latter case is particularly common, since many applications trade off video quality for a reduction in storage and/or bandwidth requirements.

Two types of artifacts, “blocking” and “ringing,” are common in video compression applications. Blocking artifacts are due to the fact that compression algorithms divide each frame into 8×8 blocks. Each block is reconstructed with some small errors, and the errors at the edges of a block often contrast with the errors at the edges of neighboring blocks, making block boundaries visible. In contrast, ringing artifacts appear as distortions around the edges of image features. Ringing artifacts are due to the encoder discarding too much information in quantizing the high-frequency DCT coefficients.

To reduce blocking and ringing artifacts, video compression applications often employ filters following decompression. These filtering steps are known as “deblocking” and “deringing,” respectively. Alternatively, deblocking and/or deringing can be integrated into the video decompression algorithm. This approach, sometimes referred to as “loop filtering,” uses the filtered reconstructed frame as the reference frame for decoding future video frames. H.264, for example, includes an “in-loop” deblocking filter, sometimes referred to as the “loop filter.”

Recent advancements in video-processing chips enable video content to be recorded at ever-higher bit rates, resulting in increased video quality during playback. For example, the bit rate for playback of Blu-ray Disc content for recent movies is approximately 18-22 Megabits per second (Mbps). While this produces great quality when the Blu-ray player is connected to an HDTV using an HDMI cable, the transfer bit-rates supported by today's streaming sources are insufficient to enable Blu-ray level QoE via network streaming, particularly when the video streaming client is a mobile device (e.g., smartphone or tablet) using a mobile network. For example, Netflix “Super HD” video (1080p) has a maximum delivery bandwidth of approximately 5800 kilobits per second (Kbps), or roughly a quarter of that used for BD content. (Netflix, as well as some other streaming media services, use adaptive bit rates that depend on the available network connection.) The available bit rate and quality of streaming video content from other sources, such as Hulu and Amazon Instant Video is comparable, while the bit rate available from VUDU HDX reaches about 9 Mbps, Zune around 10 Mbps, and iTunes about 5.4 Mbps. YouTube generally streams lower-resolution video content at lower bit rates. The bit rates for all of these streaming services is lower when streamed to a mobile device via a mobile network.

Conventional Streaming Media Delivery

The conventional approach used for video streaming employs a single streaming connection over which a bitstream comprising the encoded video content is streamed. For example, an HTTP streaming connection is opened between a video streaming server and video streaming client, and data is transferred using TCP or UDP over IP. HTTP streaming is a form of multimedia delivery of internet video (e.g., live video or video-on-demand) and audio content—referred to as video content, multimedia content, media content, media services, or the like. For convenience and simplicity, the terminology “video content” as used herein generally may refer to any type of multimedia or media content that includes video and is streamed over a network, wherein such video content may include either video-only content, a combination of video and audio content, and may further include additional content, such as content that is overlaid over the video content when viewed on a video streaming client.

In HTTP streaming, a video file can be partitioned into one or more segments and delivered to a client using the HTTP protocol. HTTP-based multimedia content delivery (streaming) provides for reliable and simple content delivery due to broad previous adoption of both HTTP and its underlying protocols, including TCP/IP. HTTP-based delivery can enable easy and effortless streaming services by avoiding network address translation (NAT) and firewall traversal issues. HTTP-based delivery of streaming content can also provide the ability to use standard HTTP servers and caches instead of specialized streaming servers.

In addition, HTTP streaming can provide several benefits, such as reliable transmission, and adaption to network conditions to ensure fairness and avoid congestion. HTTP streaming can provide scalability due to minimal or reduced state information on the server-side. However, HTTP streaming may result in latency and fluctuations in the transmission rate because of congestion control and strict flow control. Therefore, HTTP-based streaming systems include buffers to alleviate the rate variations, but as a result, users may experience latency issues when the video is being streamed.

Dynamic adaptive streaming over HTTP (DASH) is an adaptive multimedia streaming technology where a multimedia file can be partitioned into one or more segments and delivered to a client using HTTP. DASH specifies formats for a media presentation description (MPD) metadata file that provides information on the structure along with different versions of the media content representations stored in the server as well as the segment formats. For example, the metadata file contains information on the initialization and media segments for a media player (the media player looks at initialization segment to understand container format and media timing info) to ensure mapping of segments into media presentation timeline for switching and synchronous presentation with other representations. A DASH client can receive multimedia content by downloading the segments through a series of HTTP request-response transactions. DASH can provide the ability to dynamically switch between different bit rate representations of the media content as the available bandwidth changes. Thus, DASH can allow for fast adaptation to changing network and wireless link conditions, user preferences and device capabilities, such as display resolution, the type of computer processor employed, or the amount of memory resources available. DASH is one example technology that can be used to address the weaknesses of Real time protocol (RTP) and RTSP based streaming and HTTP-based progressive download. DASH based adaptive streaming, which is standardized in Third Generation Partnership Project (3GPP) technical specification (TS) 26.247 releases, including Releases 10 and 11, and the Moving Picture Experts Group (MPEG) ISO/IEC DIS 23009-1, is an alternative method to RTSP based adaptive streaming.

TCP, is a “connection-oriented” data delivery service, such that two TCP configured devices can establish a TCP connection with each other to enable the communication of data between the two TCP devices. In general, “data” may refer to TCP segments or bytes of data. In addition, TCP is a full duplex protocol. Accordingly, each of the two TCP devices may support a pair of data streams flowing in opposite directions. Therefore, a first TCP device may communicate (i.e., send or receive) TCP segments with a second TCP device, and the second TCP device may communicate (i.e., send or receive) TCP segments with the first TCP device.

IP is employed as the networking layer for TCP transfers. Accordingly, TCP segments are encapsulated into IP packets at the TCP sender and sent via the IP packets to the TCP receiver. The IP packets themselves may be encapsulated in a Layer-2 packet/frame, such as an Ethernet packet/frame or other types of frames. Upon receipt, the IP packets are de-capsulated to extract the TCP segments and the TCP segments are further processed by a TCP layer component in a networking stack. Generally, the TCP layer component may be implemented in software running on a TCP host device (e.g., a computer, smartphone, tablet, etc.), or implemented in embedded hardware at the device's network interface.

TCP is a reliable transport layer and employs a confirmed delivery mechanism to ensure all TCP segments are successfully received (received at the receiver without error). This reliability is facilitated through the use of TCP sequence numbers in the TCP segment header, and positive ACKnowledgements (ACKs) returned by the TCP receiver to confirm an accumulated sequence of bytes have been successfully received. By tracking the sequence numbers of bytes that have been received, the corresponding TCP segments that have been received may be determined. Under conventional TCP, the sender employs a retransmit timer along with TCP timestamps that results in automatic retransmission of any TCP segment for which an ACK has not been received when the timer expires. Optionally, a negative ACK (NACK) may be returned by the TCP receiver upon detection that a TCP segment or segments are missing. For example, when IP packets are streamed in packet flows over the same forwarding path, the IP packets are guaranteed to be received in sequence order, unless dropped or lost. As a result, a gap in the TCP sequence detected at the receiver means a packet was dropped or lost. In addition, a NACK can be used for an errant TCP segment (e.g., as a result of a Checksum failure). In addition, selective ACKs (SACKs) may be used to convey a missing range of bytes. The TCP sequence numbers also enable the TCP receiver to reorder TCP segments that are received out-of-order and/or to eliminate duplicate TCP segments.

An ACK message returned by a TCP receiver may include the number of bytes that the TCP receiver can receive from the TCP sender beyond the last received TCP segment. For example, the TCP receiver may communicate a highest sequence number of bytes that can be received from the TCP sender, so that the received TCP segments do not produce overrun and overflow in the TCP receiver's buffer. In general, TCP devices may temporarily store the TCP segments received from the network element in a buffer before the TCP segments are forwarded for additional processing (e.g., by an application, such as a video player). In one example, TCP segments that have arrived out-of-order may be rearranged within the TCP receiver buffer (based on the TCP segment′ associated byte sequence numbers) so that in-order TCP segments may be forwarded for further processing. The number of TCP segments that can be stored in the TCP buffer may depend on a TCP buffer size and the size of the TCP segments. In addition, an ACK message may include a next expected sequence number identifying the byte sequence number for the next TCP segment the receiver expects to receiver from the TCP sender.

Generally, for pre-recorded content, a bitstream comprising encoded video (with audio, if applicable) content is read from one or more storage devices (e.g., on a block-wise basis) by an application-level program running on the video streaming server. The video streaming server will then employ transport and network layer components implemented in software and/or hardware to “packetize” the bitstream using the applicable transport and network protocol (e.g., TCP or UDP over IP). In the case of Ethernet as the Physical layer, the TCP/IP or UDP/IP packets will then be framed in Ethernet frames and streamed as frames over the network to the destination endpoint hosting the video streaming client. Upon receipt, the IP packets and TCP segments or UDP PDU (protocol data units) will be extracted from the frames (deframing) and de-packetized to regenerate the original encoded video bitstream using applicable networking components on the destination endpoint. The bitstream will then be accessed by the video streaming client, which will temporarily store recently-received portions of the bitstream in one or more memory buffers and employ decoding and other processing operations to regenerate the original frames and audio content corresponding to the original video content.

Multiple Transport Video Streaming Embodiments

Under the multiple transport video streaming techniques now described, multiple streaming connections are opened between the video streaming server and video streaming client, wherein “high priority” content is streamed over a streaming connection that employs a reliable transport, such as TCP, while “low priority” content is streamed over one or more other streaming connections that may employ transport mechanisms under which packets may be dropped or lost, such as UDP or the modified TCP scheme described below. The high-priority and low-priority bitstreams are transmitted and received as independent bitstreams, whereupon the bitstreams are recombined and the original encoded video content is reassembled. In some embodiments, the multiple bitstreams are transmitted in parallel or otherwise concurrently or substantially concurrently. The reassembled encoded video content can then be played back on a video player application or the like, or otherwise be displayed on a display through use of such a video player application.

A basic principle of the approach is to enable video streaming with unequal error prioritization and other cross-layer optimization over existing network transport protocols with minimal changes. The encoded video bitstream is split into more and less important data at the application layer, and then standard transport protocols such as TCP and UDP are used to carry the more and less error-sensitive video data, respectively. This approach also enables easier integration of the cross-layer information from the video stream into existing network stacks, in order to provide better QoE and network resource utilization.

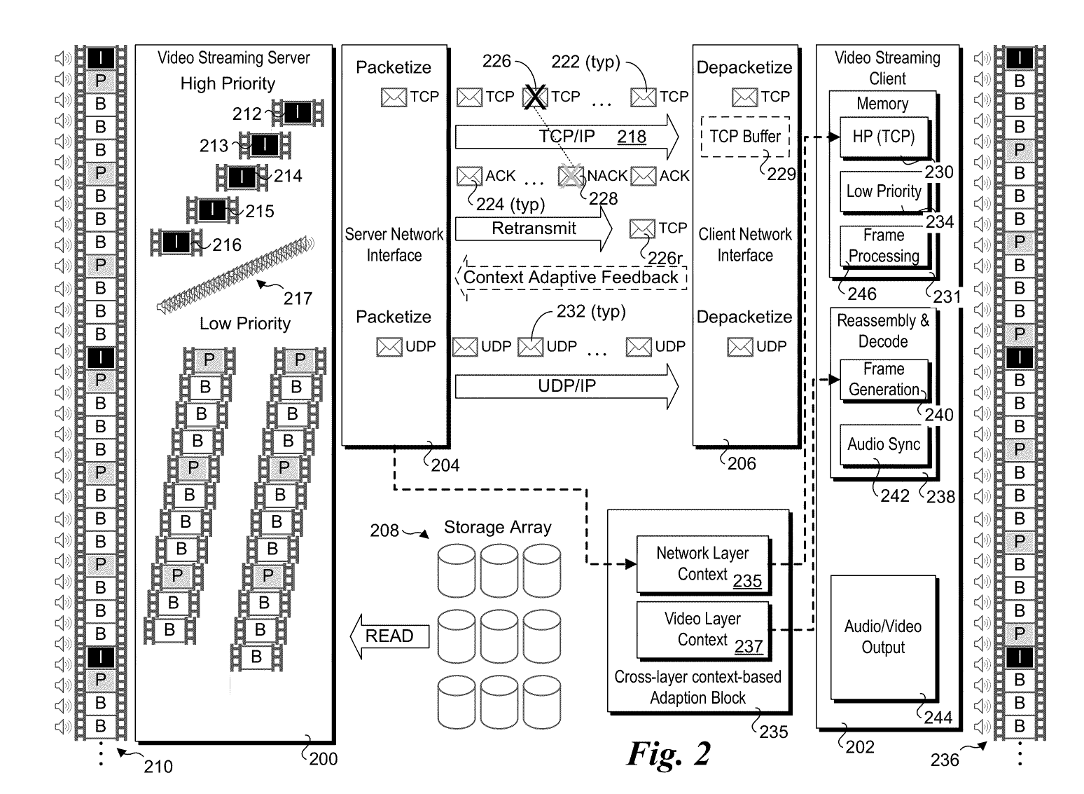

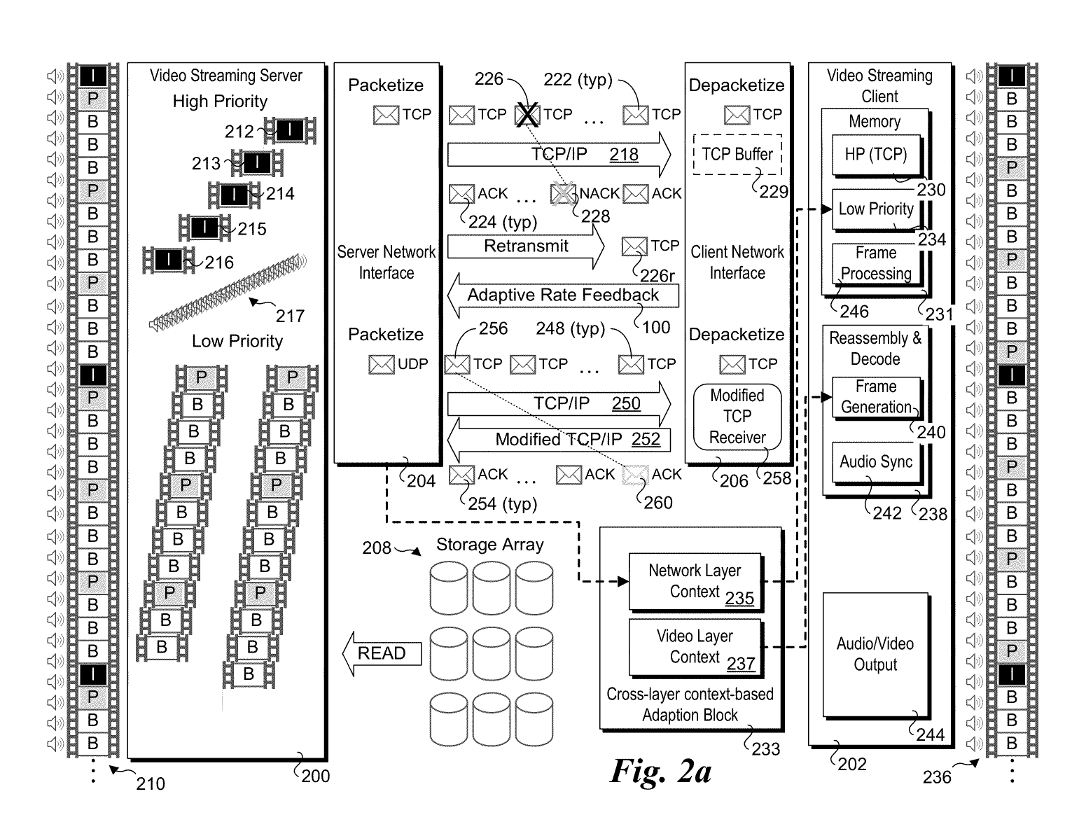

Under some embodiments, encoded content for “high-priority” frames carrying higher importance data is delivered over a reliable transport layer such as TCP, while lower importance content corresponding to “low-priority” frames is delivered over a transport layer and/or mechanism that either doesn't confirm delivery or “fakes” delivery confirmation. An example of one embodiment of this approach is illustrated in FIG. 2, which depicts a video streaming server 200 streaming encoded audio/video content to a video streaming client 202 using a pair of streams. Video streaming server 200 includes a server network interface 204 and video streaming client 202 includes a client network interface 206.

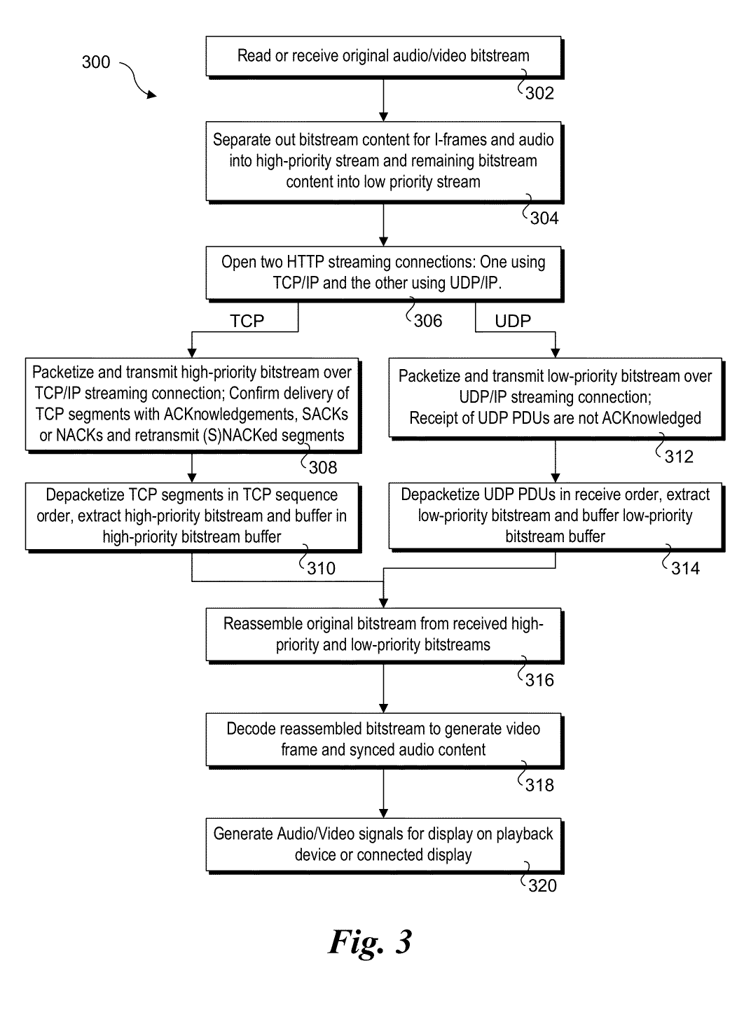

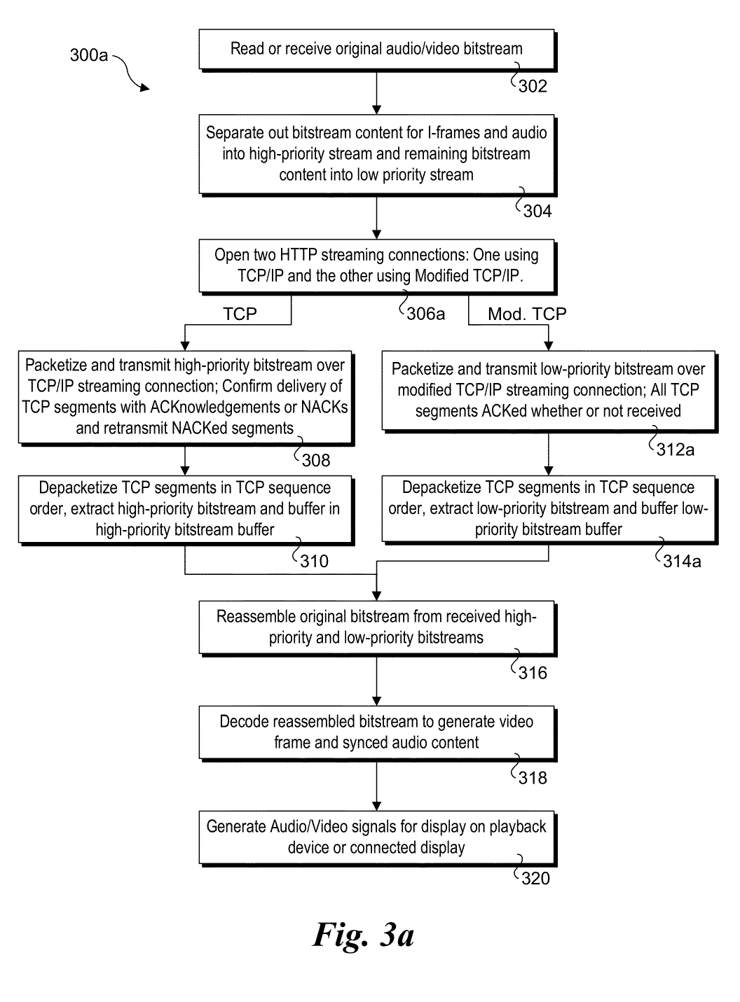

With further reference to a flowchart 300 in FIG. 3, in one embodiment video content is streamed from video streaming server 200 to video streaming client 202 using the following operations. The process begins in a block 302 in which an original video bitstream is read from storage or, optionally, received from another source, such as a video head end source or the like. As shown in FIG. 2, encoded video content is read from one or more storage devices in a storage array 208. Video content streamed from commercial streaming services such as Netflix, Amazon, VUDU, YouTube, etc. is stored in very large storage arrays in data centers or the like. The encoded video content is typically stored using a block-wise storage scheme under which identical blocks of content may be stored on separate storage devices, which facilitates faster Input/Output (I/O) access when multiple streams of the same content are being streamed to different recipients using an on-demand approach.

The video content is read from storage as an encoded bitstream, which is referred to herein as the “original” video bitstream. Depending on the applicable video encoding standard used, the video bitstream will include markers from which the encoded content for each of I-frames, P-frames, and B-frames (as well as other types of Group of Picture (GOP) content, such as B-slices) can be identified. Additionally, audio content may generally be encoded on a separate “layer,” wherein the audio content and video content includes synchronization indicia used to coordinate the playback of the audio and video content in a synchronized manner. Optionally, audio content may be encoded along with the video content in an interleaved manner.

An original encoded frame sequence 210 is used to depict a sequence of I-frames, P-frames, and B-frames in the order they are encoded in the original video content. For simplicity, a sequence of three B-frames follows each P-frame, but it will be understood that the frequency of both P-frames and B-frames may be somewhat random. To the left of encoded frame sequence 210 is a sequence of audio icons used to indicate audio content that is encoded on a separate layer.

As depicted in a block 304 of flowchart 300, as the original encoded bitstream is processed at video streaming server 200, the portion of the bitstream corresponding to the I-frames and audio content is separated from the remaining portion of the bitstream comprising the encoded P-frames and B-frames. The I-frame and audio bitstream content is added to a high priority stream, while the remaining P-frame and B-frame bitstream content is added to a low priority bitstream, as illustrated in FIG. 2 using corresponding frame icons and audio icons.

Under one aspect of the multiple transport scheme, the I-frame and audio content is delivered asynchronously with respect to the P-frame and B-frame content. For example, FIG. 2 shows that five I-frames 212-216 have been processed and transmitted to video streaming client 202 by the time the P-frames and B-frames in the portion of encoded frame sequence 210 has been processed. By sending portions of the I-frame and audio content in advance (or corresponding P-frame and B-frame content), any TCP segments conveying such I-frame and audio content that are dropped, lost, or otherwise received as errant data may be retransmitted under TCP such that the delay resulting from retransmission doesn't adversely affect delivery of the video content as a whole.

Continuing at a block 306, two HTTP streaming connections are opened. A first HTTP over TCP/IP streaming connection 218 is opened using TCP as the transport layer and IP (Internet protocol) as the network layer. A second HTTP over UDP/IP streaming connection 220 uses UDP as the transport layer and IP as the network layer. It is noted that the operations in block 306 may be performed either after the operations of blocks 302 and 304, beforehand, or concurrent with these operations.

In a block 308 the high-priority bitstream is packetized into TCP/IP packets 222 at server network interface 204 and streamed over HTTP over TCP/IP streaming connection 218. Each TCP/IP packet includes a TCP segment encapsulated in an IP packet, which is further encapsulated in a link layer packet or frame, such as an Ethernet packet or a wireless networking packet such as for IEEE 802.11 WLANs or for 3GPP LTE networks. (The terminology TCP segment is used herein; the use of TCP “packets” is also commonly used, while both segments and packets are technically the TCP PDU.) For simplicity, the transfer of bitstream content between video streaming server 200 and video streaming client 202 is shown as a series of TCP segments or UDP PDUs over a single Physical layer, such as Ethernet in the examples herein; however, for video streaming clients that receive content wirelessly, a portion of the transfer path will employ a wireless Physical layer, such as IEEE 802.11 (WiFi™) or an applicable mobile server Physical layer (e.g., an LTE Physical layer).

By way of example using an Ethernet Physical layer for the complete transfer path, Ethernet packets, in turn, are transferred in Ethernet frames. As the Ethernet frames conveying the TCP/IP packets are received at client network interface 206 they are deframed, and de-encapsulation operations are performed to extract the TCP segments, which are checked for errors. In addition, the TCP sequence number is checked, and a running tally of received sequence numbers is updated. In accordance with the TCP protocol, delivery of successfully received TCP segments (via corresponding TCP byte sequence numbers) is confirmed with TCP ACKs 224, while in the illustrated embodiment missing or errant TCP segments are indicated with NACKs or SACKs. In response to receiving a NACK or SACK identifying a given TCP sequence number, the corresponding TCP segment is identified and retransmitted from server network interface 204 over HTTP over TCP/IP streaming connection 218. (Under TCP practices, transmitted TCP segments remain in the TCP sender's transmit buffer until delivery of the TCP segment is received, enabling TCP segments to be readily retransmitted.) As illustrated in FIG. 2, a TCP/IP packet 226 is dropped, lost, or otherwise is received with an error. In response, a NACK 228 identifying the TCP segment's byte sequence number in TCP/IP packet 226 was not successfully received is returned to server network interface 204, which, in turn, resends the corresponding TCP segment in a TCP/IP packet 226r.

In further detail, TCP layer operations may be performed at a network interface and/or using an operating system TCP layer processing component (e.g., as part of the OS network stack). FIG. 2 depicts a TCP buffer 229 shown in dashed outline to client network interface 206 to indicate it is optional, and a high-priority bitstream buffer 230 in memory 231 that is labeled “HP (TCP)” to indicate this buffer may also be used to support TCP layer processing. TCP uses the TCP byte sequence number to reorder the byte sequence in the TCP segments that are received out-of-order for TCP transfers between source and destination endpoints that may involve multiple different paths, and for identifying missing TCP segments in a packet flow using the same path or for bitstream transfers using multiple different paths. For packet flows, a missing sequence number can be used to immediately identify a TCP segment has been dropped or lost. Since transfer latencies across different paths may vary, the out-of-order receipt possibility makes identifying missing sequence numbers a bit more difficult, but these can be detected if packets adjacent in the sequence have been received and the missing sequence number packet has yet to be received within some predefined timeframe or through a similar mechanism.

As sequential runs of TCP segments are identified, they may be immediately forwarded for addition processing, such a frame processing operations described below. Conversely, in one embodiment, TCP segments in sequences following a missing TCP segment are buffered until the missing TCP segment has been received via a retransmission, after expiration of a timer, or to prevent a buffer overflow. The timer may typically be set based on a round trip time (RTT) incurred in transfer between the source and destination endpoints plus some time margin. Likewise, under embodiments that do not employ NACKs or SACKs, a similar RTT timer scheme may be employed at the sender, whereby if an ACK hasn't been received when the timer expires, the packet is retransmitted. As yet another option, the combination of NACKs (and/or SACKs) and automatic retransmissions may be used. The advantage of this approach is that it addresses the situation of a NACK or SACK being dropped, lost, or is otherwise errant when received. Either TCP retransmission scheme may be used, but the use of NACKs is generally preferred for streaming connections employing packet flows, since it eliminates the extra latency added by the RTT time margin. Depending on the size allocated for TCP buffering and other factors, a TCP connection may provide sufficient buffering to enable a missing or errant packet to be retransmitted one or more times.

In a block 310 the TCP segments that are forwarded for further processing are processed in sequential order, and the high-priority bitstream is extracted and buffered in high-priority bitstream buffer 230. In this manner, the bitstream data in high-priority bitstream buffer 230 will be the same as the I-frame and audio bitstream data separated out in block 304 for instances in which all TCP segment have been successfully delivered. As described below, in some embodiments a cross-layer context-based adaptive streaming rate scheme may be implemented to ensure the ratio of TCP segments that are successfully received is sufficiently high to ensure good QoE. These operations are implemented via use of a cross-layer context-based adaption block 233 including a network layer context block 235 and a video layer context block 237.

Meanwhile, the operations depicted in blocks 312 and 314 are performed in substantially concurrently with the operations of blocks 308 and 310. As before, the low-priority bitstream is packetized at network interface 204 and transmitted over HTTP over UDP/IP streaming connection 220 to client network interface 206 as a stream of IP packets encapsulating UDP PDUs 232. However, unlike with TCP, successful receipt of UDP PDUs is not ACKnowledged. Rather, the bitstream data contained in any UDP PDUs that are not received successfully at client network interface 206 will be missing.

In block 314 the UDP PDUs 232 are de-packetized, and the lower-priority bitstream data is extracted and buffered in receive order in a low-priority bitstream buffer 234. Thus, the bitstream data in low-priority bitstream buffer 234 will be the same as the lower-priority P-frame and B-frame bitstream data separated out in block 304.

In a block 316, the original bitstream corresponding to the original encoded frame sequence 210 and audio content is reassembled from the high-priority and low-priority bitstream data. Generally, the frame content may be encoded with information via which the original encoded frame sequence 210 may be recreated, or such information may be added to each of the high- and low-priority bitstreams at the time they are created. In a block 318 the reassembled bitstream is decoded using an applicable decoder to generate video frame data and synchronized audio content. This results in generations of a playback frame sequence 236 with synchronized audio content, as depicted at the right-hand side of FIG. 2. As noted above, the encoded order of frames and the playback order of displayed frames may differ. Audio and video signals for displaying the frames on a display and playing back the audio content through an audio sub-system including speakers are then generated in a block 320. Depending on the type of device used for video streaming client 202, the video and audio content may be played back on the same device, or it may be displayed on a device that is connected to video streaming client 202 via a wired or wireless connection.

As shown in FIG. 2, video streaming client 202 includes various components for implementing the operations of blocks 316, 318, and 320, including a reassembly and decode block 238 that comprises a frame generation block 240 and an audio sync block 242, and an audio/video output block 244. A portion of memory 231 depicted as a frame processing buffer 246 is also shown to illustrate that additional buffering is performed during this generation of playback video frames and audio content.

The size of the high-priority and low-priority bitstream buffers 230 and 234 may generally depend on the level of buffering required to ensure a desired playback smoothness is obtained. For example, in most implementations it will be desired that once playback starts there will be no delays as a result of buffering. In other instances, it may be difficult to avoid such buffering if the transfer rate of the streaming connection is insufficient and/or if there is buffering that results from retrieval problems at the video streaming server.

Some network environments, such as portions of a private network behind a firewall, are unable to receive UDP traffic for security reasons. To address this, an alternative scheme is provided that employs a modified TCP HTTP streaming connection. Under this scheme, both the high-priority and low-priority bitstreams are transported over separate TCP HTTP streaming connections. The high-priority bitstreams are handled in the same manner described above. However, under the modified TCP approach, all TCP segments are ACKed whether or not they are successfully received. From the perspective of the video streaming server and network firewall, the modified TCP streaming connection operates like a conventional TCP streaming connection; the only modification is on the client-side at the receiving video streaming client.

FIGS. 2a and 3a respectively show a system architecture and a flowchart 300a illustrating operations to support an alternative scheme that employs the modified TCP transmission scheme for the low-priority bitstream. Generally, like-numbers components and blocks in FIGS. 2 and 2a and FIGS. 3 and 3a perform similar operations. Accordingly, the following discussion focuses on the differences between the UDP scheme and the modified TCP scheme.

As depicted in a block 306a of flowchart 300a, two HTTP over TCP/IP streaming connections are opened; a conventional TCP/IP connection and a modified TCP/IP connection. It is noted that both HTTP over TCP/IP streaming connections may be opened as conventional HTTP over TCP/IP streaming connections—only the receiver is operating in a modified manner, and the connection itself may be implemented in compliance with existing TCP/IP and HTTP streaming standards. The use of “modified” in block 306a is merely to distinguish the two HTTP streaming connections.

In a block 312a, the low-priority bitstream is packetized as a stream of TCP segments 248 encapsulated in IP packets and transmitted from server network interface 204 to client network interface 206 via a HTTP over TCP/IP streaming connection 250. As stated above, from the perspective of server network interface 204, this appears to be a conventional HTTP over TCP/IP streaming connection. As depicted by a modified HTTP over TCP/IP streaming connection 252, ACKs 254 are returned for all of the transmitted TCP segments, whether they are actually successfully received, or not. For example, although an IP packet containing a TCP segment 256 has been dropped, a modified TCP receiver module 258 returns a “fake” ACK 260 to the server network interface 204. It is noted that in connection with cross-layer context-based adaption, there may be instances in which a “fake” ACK is not returned in response to a first transmission of a TCP segment that is not received; however, eventually a real or “fake” ACK will be returned for each TCP segment such that the TCP sender will stop trying to retransmit the same TCP segment. Further details of this are described below.

In a block 314 of flowchart 300a, the TCP segments that are successfully received are de-packetized in TCP sequence order to extract the low-priority bitstream, which is then stored in an LP (low priority) (TCP) bitstream buffer 262. As discussed above with respect to HP (TCP) buffer 230, received TCP segments may be buffered at client network interface 206 and/or LP (TCP) buffer 262, depending on the particular implementation.

Generally, the modified HTTP over TCP/IP streaming connection may yields a similar result as a HTTP over UDP/IP streaming connection when considering the portion of the low-priority bitstream content that is actually received. In both cases, dropped, lost, or otherwise errant PDUs carrying low-priority bitstream data results in missing data. However, since TCP and UPD traffic may be forwarded using different classes of service, the result obtained using HTTP over TCP/IP may be better or worse than that obtained using a HTTP over UDP/IP streaming connection. For example, since TCP is reliable traffic, it may be less likely a TCP segment is dropped at a switch along the forwarding path. Conversely, the effective transfer bandwidth employed for the two different traffic classes may differ such that one of the traffic classes (e.g., UDP) may support a greater bandwidth. Also, when combined with cross-layer context-based adaption, selective missing TCP segments may be requested to be retransmitted based on the relative importance of the data contained in those missing TCP segments, while other missing TCP segments carrying less-important data may be ignored (and thus remain missing in the bitstream data forwarded for further processing).

In addition to use with streaming video formats such as H.264/MPEG4/AVC and VC-1, embodiments may be implemented that support scalable video streaming. Under one embodiment, video content encoded in accordance with the H.264/MPEG4-AVC with SVC (Scalable Video Coding) extension is separated into high-priority and low-priority bitstreams and transferred using multiple HTTP streaming connections in a manner similar to those shown in FIGS. 2 and 2a.

H.264/MPEG4-AVC with SVC extension (referred to herein as H.264/SVC) encodes video and audio content using multiple multiplexed layers, including a base layer and one or more enhancement layers. In general, the coder structure and coding efficiency will depend on the scalability space required by the application. Most components of H.264/MPEG4-AVC are used as specified by the standard. This includes the motion-compensated and intra prediction, residual processing, weighted prediction, macro-block coding, etc. The base layer of an SVC bitstream is generally encoded in compliance with H.264/MPEG4-AVC such that a standard conforming H.264/MPEG4-AVC decoder is capable of decoding this base layer representation when it is provided with an SVC bitstream. Tools are added for supporting spatial and SNR (signal-to-noise ratio) scalability.

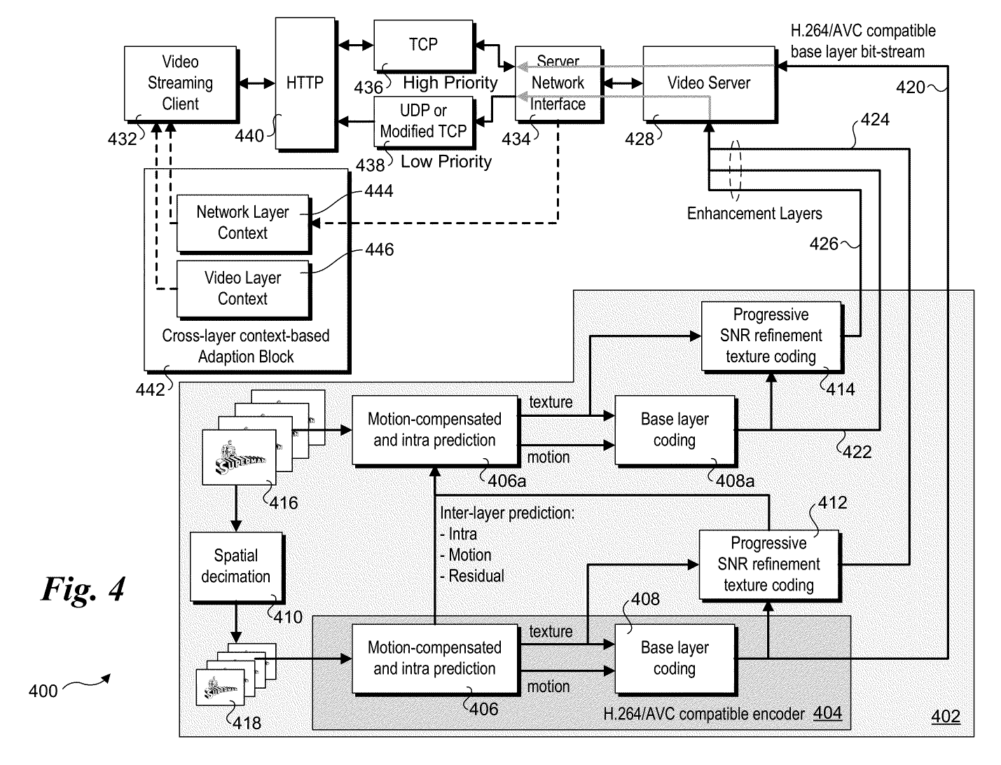

FIG. 4 illustrates an exemplary H.264/SVC multiple transport streaming implementation 400, according to one embodiment. The SVC video bitstream content is generated by a H.264/SVC coder 402 with two spatial layers including an H.264/MPEG4-AVC base layer and three enhancement layers. Details of an H.264/SVC coder having a similar configuration is described in a paper entitled, overVIEW OF THE SCALABLE H.264/MPEG4-AVC EXTENSION, H. Schwarz, D. Marpe, and T. Wiegand, Fraunhofer Institute for Telecommunications—Heinrich Hertz Institute, Image Processing Department (2006).

As described in this paper, in each spatial or coarse-grain SNR layer, the basic concepts of motion-compensated-prediction and intra prediction are employed as defined in the H.264/MPEG4-AVC specification. The redundancy between different layers is exploited by additional inter-layer prediction concepts that include prediction mechanisms for motion parameters as well as texture data (intra and residual data). A base representation of the input frames of each layer is obtained by transform coding similar to that of H.264/MPEG4-AVC, the corresponding Network Adaptation Layer (NAL) units contain motion information and texture data; the NAL units of the lowest layer are compatible with single-layer H.264/MPEG4-AVC. The reconstruction quality of these base representations can be improved by an additional coding of so-called progressive refinement slices. Additionally, the corresponding NAL units can be arbitrarily truncated in order to support fine granular quality scalability or flexible bit-rate adaptation.

An important feature of the SVC design is that scalability is provided at a bit-stream level. Bit-streams for a reduced spatial and/or temporal resolution can be simply obtained by discarding NAL units (or network packets) from a global SVC bit-stream that are not required for decoding the target resolution. NAL units of PR slices can additionally be truncated in order to further reduce the bit-rate and the associated reconstruction quality.

H.264/SVC coder 402 includes an H.264/MPEG4-AVC compatible encoder 404 having a motion-compensated and intra prediction block 406 and a base layer coding block 408. For the enhancement layers, a similar motion-compensated and intra prediction block and a base layer coding block is provided, as depicted by a motion-compensated and intra prediction block 406a and a base layer coding block 408a. Also depicted is a spatial decimation block 410, and a pair of progressive SNR refinement texture coding block 412 and 414.

The processes starts with video content comprising a sequence original frames or “pictures” 416. While it is possible to have SVC implemented in real-time as frame content is captured (e.g., using an advanced video camera), most SVC content is currently generated during post-processing operations. In one exemplary use case, the original frame content comprises frame content that has been previously encoded at a high quality level beyond that typically used for video streaming, such as an H.264/MPEG4-AVC quality level used for movies on Blu-ray Disc. To create the H.264/MPEG4-AVC base layer bitstream, spatial decimation block 410 performs a spatial decimation of original frames 416, generating spatially-decimated frames 418. A similar processing sequence is then performed on each of original frames 416 and spatially-decimated frames 418, as shown. This results in generation of H.264/MPEG4-AVC compatible base layer bitstream 420 and respective bitstreams 422, 424 and 426 output by base layer coding block 408a and progressive SNR refinement texture coding blocks 414, which are multiplexed at or before a video streaming server 428 to form an enhancement level bitstream 430. An enhancement layer bitstream may also be referred to as a “sub-stream.”

Under a normal H.264/SVC streaming operation, the base layer bitstream and one or more enhancement layer bitstreams are combined (multiplexed) and transmitted as a single multiplexed bitstream from a video streaming server to a video streaming client. Upon receipt at the video streaming client, the bitstream is de-multiplexed, and the base layer and enhancement layer bitstream content is processed to generate the displayed frame content in accordance with the H.264/SVC decoder specification.

Under the SVC multiple transport streaming implementation 400 scheme shown in FIG. 4, H.264/MPEG4-AVC compatible base layer bitstream 420 is transferred from video streaming server 428 to a video streaming client 432 as a high-priority bitstream, while enhancement layer bitstream 430 is transferred as a low-priority bitstream. As before, the high-priority bitstream is transferred by sending TCP/IP packets using an HTTP streaming connection, while the low-priority bitstream is transferred by sending UDP PDUs or TCP/IP packets using an HTTP over UDP or HTTP over a modified TCP streaming connection. The illustrated components for implementing this include a server network interface 434, a TCP block 436, a UDP or modified TCP block 438, and an HTTP block 440. Although not shown, video streaming client would include or otherwise be connected to a client network interface similar to client network interface 206 in FIGS. 2 and 2a.

FIG. 4 further depicts a cross-layer context-based adaption block 442 including a network layer context block 444 and a video layer context block 446. The operation of these cross-layer context-based adaption blocks are explained in the following section.

Streaming Via Cross-Layer Context-Adaptive Modified TCP Connections

In accordance with further aspects of some embodiments, HTTP/TCP-based video streaming may be improved by using characteristics of the video data and/or the transport network. As a result, the HTTP/TCP-based video streaming may experience reduced delay and/or improved video quality. In particular, cross-layer information from the application layer and the network layer may be combined to modify the functionality of the TCP receiver. Since the modifications to the TCP receiver may be implemented on the client-side, modifications to the network infrastructure may not be necessary. The modification to the TCP receiver may improve rebuffering, average picture quality, number of rate switches, etc. As a result, the user quality of experience (QoE) may also be improved.

As discussed above, a TCP receiver may determine that a TCP segment is missing and take appropriate action (e.g., send a SACK or NACK, as applicable). In response, the missing TCP segment may be retransmitted. As used herein below, the retransmitted TCP segment is referred to as a “delayed” TCP segment. The TCP receiver may determine whether the delayed TCP segment is received within a predefined time threshold. In one example, the predefined time threshold may be dynamically configured based on network layer information and application layer information.

In addition, the TCP receiver may determine whether the delayed TCP segment has a lower priority level, as compared to the other TCP segments being communicated to the TCP receiver. The TCP receiver may determine that the delayed TCP segment has the lower priority level using the application layer information and the network layer information. The network layer context information may include at least one of: explicit loss indication including media access control (MAC) layer packet loss, loss due to congestion inferred via TCP receiver buffer content analysis, or explicit network congestion information. The application layer context information may include at least one of: buffer status, frame type, saliency of video frames, type of video content, as well as other context such as device context information, or user context information.

If the delayed TCP segment is determined to have a lower priority level (based on the application and network layer information) and the delayed TCP segment is not received at the TCP receiver within the predefined time threshold, then the delayed TCP segment may be dropped. This will results in the delayed TCP segment data not being including in the bitstream data that is forwarded for further processing. In addition, the TCP receiver may send a fake ACK message to the network element falsely acknowledging that the TCP receiver received the formerly missing TCP segment (as indicated by the byte sequence number in the fake ACK).

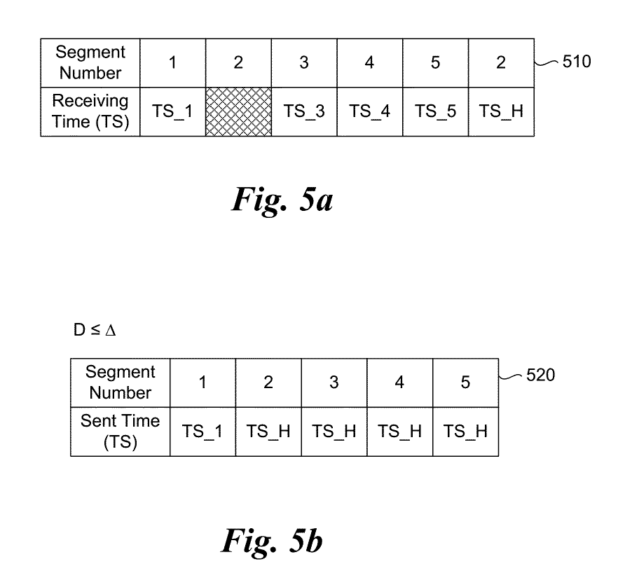

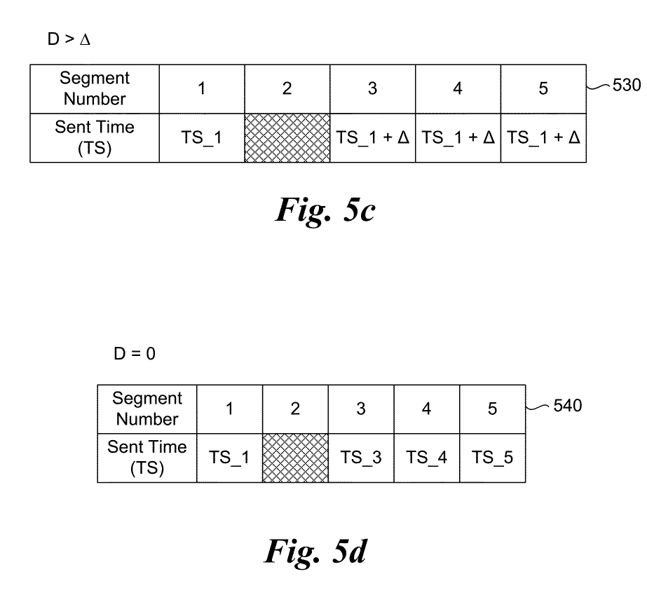

FIG. 5a illustrates a plurality of transmission control protocol (TCP) segments 510 being transferred to a TCP receiver. In particular, the TCP segments may be received at a TCP receiver and buffered in a TCP receiver buffer. The plurality of TCP segments that are received at the TCP receiver may include a missing TCP segment (as identified by a gap in the received byte sequence numbers). For example, as shown in FIG. 5a segment 1 is received at Time (TS_1), segment 2 has yet to be received, segment 3 is received at TS_3, segment 4 is received at TS_4, and segment 5 is received at TS_5.

As each TCP segment is received and processed, the sequence number in the TCP segment's header is inspected. The sequence number represents the cumulative number of bytes that have been transmitted from the TCP sender. When the TCP receiver receives segment 3, it detects a gap in the sequence number, and thus detects that segment 3 has been received out-of-order. In response, the TCP receiver may return a NACK or SACK to the TCP sender containing information identifying the segment with the byte sequence number that was not receive (via the NACK) or identifying byte sequence numbers for segments that have been received (via the SACK), such as for segments 1 and 3. As another option, in accordance with the original TCP specification, an ACK message may only be returned for segment 1 at this point.

In response to receiving the NACK or SACK, or, alternatively, after expiration of the retransmit timer for segment 2, the TCP sender may retransmit segment 2. In one embodiment, TCP segments following a missing TCP segment will remain the TCP receiver buffer until the missing TCP segment has been received or to prevent a TCP buffer overflow.

As illustrated in FIG. 5a, the TCP receiver has received a retransmitted segment 2 at a time (TS_H) after segments 3, 4 and 5 have been successfully delivered to the TCP receiver buffer. At this point, each of segments 2, 3, 4, and 5 may be forwarded for further processing (this presumes that segment 1 was previously forwarded). Additionally, the bitstream that is forwarded for further processing is reordered (relative to the segment receiving order) so that the byte sequence number of the segments are in correct order. If configured to operate under the original TCP specification (which didn't support SACKs), the TCP receiver may return an ACK identifying the sequence number for segment 5 has been received.

Generally, the process of IP packet receipt, TCP segment extraction and buffering, and segment reorder proceed a decoding sequence that is implemented as a pipelined set of operations. The entire pipeline of operations is implemented in a manner that accounts for some variability in the latency incurred during the decoding, since the amount of data required to decode some frames may be greater or less than that used for other frames. For instance, frames associated with a larger degree of motion are encoded with a greater amount of data than frames associated with a less degree of motion. There is also some tolerance that is typically built-in for network delays, such as results from retransmission of TCP segments. However, if the network delay becomes too excessive, it may negatively impact the decoding pipeline such that display of frames at the playback frame rate cannot be maintained.

Accordingly, in one embodiment the TCP receiver may determine whether the delayed TCP segment is received within a time threshold (Δ). The time threshold (Δ) may be implemented to reduce the delay of bitstream data being forwarded to the decode pipeline. In one embodiment, the time threshold (Δ) may be determined using a feedback mechanism, application layer information, and/or network layer information. The delay may result from one or more delayed TCP segments being delivered to the TCP receiver buffer out-of-order (e.g., the delayed TCP segments are delivered late), which in turn, affects when the delayed TCP segments and/or out-of-order segments (e.g., TCP segments that were to be delivered after the delayed TCP segments) are forwarded to the decode pipeline.

FIGS. 5b-5d respectively depict three cases illustrating the delay (D) of TCP segments being forwarded to the decode pipeline in relation to the time threshold (Δ). In Case 1 (shown in FIG. 5b), the delay (D) may be less than or equal to the time threshold (Δ). In Case 2 (shown in FIG. 5c), the delay (D) may be greater than the time threshold (Δ). In Case 3 (shown in FIG. 5d), the time threshold (Δ) may be zero.

In further detail, FIG. 5b illustrates the forwarding of a plurality of TCP segments 520 (e.g., segments 1-5) from a TCP receiver buffer to a video decoder (that implements the decode pipeline operations). When segment 1 is received, it is forwarded to a buffer used for the decoder bitstream. When segment 2 is received at the TCP receiver buffer within the time threshold (Δ) (i.e., D≦Δ), bitstream data transferred via segments 2-5 are reordered and forwarded to the decoder bitstream buffer. In this example, although segment 2 was received at TS_H, the delay (TS_H−TS_1) is acceptable because it is less than the time threshold Δ.

When the delayed segment is received at the TCP receiver buffer within the time threshold (Δ), the TCP receiver may not determine a priority level associated with the delayed segment. In general, the priority level of the delayed segment may be determined using application layer information and/or network layer information. In other words, in Case 1, the TCP receiver may deliver the TCP segments to the display device (without using the delayed segment's priority level) when the delayed segment is communicated to the TCP receiver within the time threshold (Δ).

FIG. 5c illustrates times at which TCP segments 530 (segments 1, 3, 4, and 5) are forwarded to the decoder bitstream buffer. As shown, when segment 2 is not received at the TCP receiver buffer within the time threshold (Δ) (i.e., D>Δ), upon expiration Δ the plurality of segments following segment 2 (e.g., segments 3-5) are forwarded to the decoder bitstream buffer. In this case, the forwarded bitstream data will be missing the portion of the bitstreams transferred via segment 2, since it wasn't received within the time threshold (Δ). If or when segment 2 is subsequently received (after Δ), its delay is not acceptable and segment 2 is dropped. In the illustrated example of FIG. 1C, the portion of the bitstream transferred via segment 1 is forwarded at TS_1, and segments 3-5 are forwarded at TS_{—}1+Δ, wherein the Δ represents the period of time when the TCP receiver waited for segment 2 to be delivered.

As discussed in further detail below, when the delayed segment is not received at the TCP receiver buffer within the time threshold (Δ), the TCP receiver may determine a priority level associated with the delayed segment. For example, the priority level of the delayed segment may be determined using application layer information and/or network layer information. In one configuration, the TCP receiver may drop the delayed segment (e.g., segment 2) when the delayed segment is not received within the time threshold (Δ) and based on the priority level of the delayed segment.

FIG. 5d illustrates times at which a plurality of TCP segments 540 (e.g., segment 1 and segments 3-5) are received at the TCP receiver and D=0. The depicted receive times correspond to those shown in FIG. 1A but prior to the time segment 2 is received. As shown in FIG. 1D, when segment 2 is received at the TCP receiver buffer late (i.e., Δ=0), then the plurality of segments (other than the delayed segment) are forwarded to the decoder bitstream buffer. As with Case 1, when the time threshold (Δ) equals zero, the TCP receiver may not determine a priority level associated with the delayed segment. In other words, in Case 3, the TCP receiver may drop the delayed TCP segment out of the plurality of TCP segments being forwarded to the decoder bitstream buffer without using the delayed segment's priority level.

In general, the out-of-order delay experienced by TCP segments in the TCP receiver buffer may be: Un-ordered Delivery Delay (D=0)≦Δ≦In-Order Delivery Delay (D=TsH−TS_1). With complete un-ordered delivery, all late out-of-order TCP segments may be treated as missing bitstream data that is not forwarded to the decoder bitstream buffer. With in-order delivery, the TCP segments may forwarded to the decoder bitstream buffer without any missing data. Thus, by adjusting Δ, the tradeoff between TCP packet loss and latency may be derived from the application layer information and the network layer information.

In one configuration, the TCP receiver may use the priority level of the delayed segment (i.e., the segment that was originally missing, but delivered at a later time) to determine whether to drop the delayed segment when the delayed segment is not received at the TCP receiver within the time threshold (Δ). Alternatively, the TCP receiver may use the priority level of the delayed segment to determine whether or not to drop the delayed segment, even when the delayed segment is not received at the TCP receiver within the time threshold (Δ). In general, the application layer information and/or network layer information may indicate that a reduction in video quality outweighs the video latency resulting from the delayed segment. In other words, the reduction in video quality may be preferred over waiting for the video to load. Thus, rather than waiting for the delayed segment to be delivered, the TCP receiver may drop the delayed segment altogether in response to analyzing the application and network layer information.

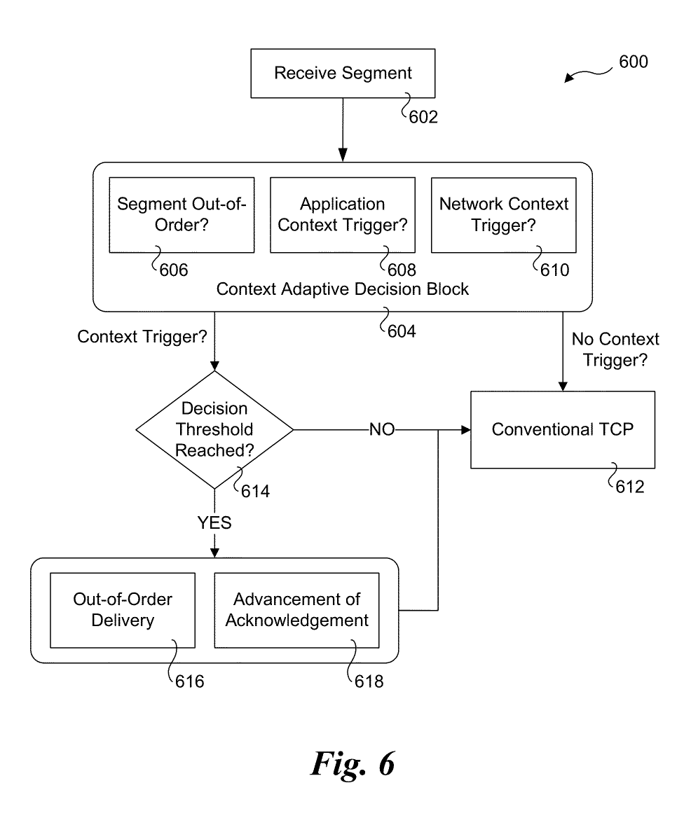

FIG. 6 illustrates a system 600 for context adaptive transfer of TCP segments, according to one embodiment. A TCP receiver receives a TCP segment at a block 602, whereupon its segment header is inspected by a context adaptive decision block 604. The context adaptive decision block includes logic for determining whether or not a context trigger applies for the TCP segment. This logic includes a segment out-of-order block 606, an application context trigger block 610, and a network context trigger block 610.

Segment out-of-order block 606 determines whether the TCP segment is received out-of-order. A determination to whether a TCP segment is received in order may be performed by inspecting the byte sequence number for the segment and the immediately-preceding received segment in combination with the size of the segment. Subsequently, the out-of-order segment may be received. For ordered packet flows, an out-of-order segment identified the segment was either dropped, lost, or received with an error and needs to be retransmitted.

Context adaptive decision block 604 may also determine whether an application context trigger should apply to a delayed TCP segment via logic in application context trigger block 608. In other words, the application context information may enable the TCP receiver to determine whether delayed TCP segments should be dropped, such that following TCP segments received in order following a gap left by the delayed TCP segment are forwarded for further processing without the delayed TCP segment. A variety of application context information regarding the multimedia information may be identified, such as playback buffer status, frame type or other saliency information for the next video frame expected in the playback buffer, history of information on recent rate switches performed by the adaptive streaming player, etc. The application context information may be obtained from modifications to the client implementation of the DASH or other HTTP adaptive streaming player software on the client.

The application layer context information may include buffer status and history, frame type, saliency, content type, as well as other context such as device context and/or user context. For example, the video data in the playback buffer and the TCP receiver's buffer may have unequal priority for different portions of the data stream (e.g., the video data may have unequal priority depending on whether the video frame is an I-frame, P-frame, or B-frame). As another example, when the application is approaching playout buffer starvation and/or the video information expected from the TCP receiver at the tail of the playback buffer is determined to be a B-frame, context adaptive decision block 604 may be provided this information in order to determine whether the B-frame should be dropped.

Adaptive streaming clients may use buffer status and history for rate adaptation decisions. In addition to the current buffer status, the application may also provide a history of video rate switches (e.g., adaptations) made in the immediate past. The history of video rate switches may be useful because the user QoE may also be impacted by a frequency associated with rate switching.

The frame type may affect whether a delayed TCP segment may be dropped. I-frames and P-frames have temporal dependencies that have a large impact on subsequent frame decoding, while B-frames do not have forward temporal dependencies and thus can be dropped with smaller picture quality impact. As an example, the I/P/B frame Group of Pictures (‘GOP’) structure may enable the video player to determine the location of the next expected P-frame relative to the next I-frame in the sequence. Thus, the impact of potentially dropping that P-frame may be estimated. The frame type information may be explicitly accessible in frame headers by the video player.

In one example, saliency (e.g., an importance of a given frame) in terms of visual impact may be used by the video player. For example, if H.264/SVC is used, enhancement layer data may have less importance in comparison to base layer video data. Application context information regarding the saliency may be available explicitly in frame headers or may be provided through other mechanisms.

In addition, the video application may tailor the trade-off between re-buffering and picture quality differently depending on whether the content being viewed is live content or video on demand (VOD). Also, the video application may tailor the trade-off between re-buffering and picture quality depending on whether the content is related to sports, news, etc. Application context information regarding the content type may be provided in content metadata.

In one embodiment, the context information may include device context information. The screen size may play a role in user perception and expectations. The device battery level may be used as context input, as tradeoffs of quality and throughput may be different based on the remaining battery level of the device.

In an additional example, the context information may include user context information. For example, mobile users may face different situations with respect to packet loss, delay and/or throughput as compared to nomadic/fixed users. In addition, users may have different QoE expectations depending on whether the content is free or subscription-based.

Context adaptive decision block 604 may also employ logic in network context trigger block 610 to determine whether a delayed TCP segment includes a network layer context trigger. In other words, the network layer context information may determine whether the delayed TCP segment should be dropped, such that following TCP segments received in order following a gap left by the delayed TCP segment are forwarded for further processing without the delayed TCP segment. Network layer context information may be combined with the TCP processing at the TCP receiver. The network layer context information may include explicit cross-layer information from the network interface (e.g., media access control (MAC) layer re-transmit failure indication), or explicit congestion notification from network elements.

In addition, the network layer context information may be obtained based on analysis of the TCP receiver buffer contents (e.g., statistics of missing TCP segments awaiting retransmission). Network congestion related losses may be differentiated from losses due to wireless link layer errors on the uplink/downlink. In one example, the network layer context information may be derived from modifications to a network interface card (NIC) driver, etc. In addition, logic in context adaptive decision block 604 may analyze the network context layer information (e.g., analyze the TCP receiver buffer for segment gaps and associated statistical information, integrate feedback from lower layers regarding wireless/congestion loss), and adjust the threshold (Δ) for outstanding segments that may be released.

Thus, the network layer context information may enable the TCP receiver to determine whether delayed segments should be dropped. The network layer context information may include an indication of a MAC layer packet loss (e.g., a retransmission timeout). The indication may be from a NIC or a modem that indicates a missing IP packet. The indication of the MAC layer packet loss may be an explicit signal to the TCP receiver that the missing data is due to wireless link errors as opposed to network congestion. In addition, the network layer context information may be obtained from TCP receiver buffer content analysis. In particular, the statistics associated with the missing segments in the TCP receiver buffer may be examined to provide contextual information about whether wireless link (e.g., random) losses or congestion related (e.g., large burst of holes) losses are being experienced at the TCP receiver buffer.

In one example, the network layer context information may include an explicit congestion notification (ECN) marking in the IP header in order to provide the TCP receiver with network layer context information regarding the TCP segment holes. In one example, the network layer context information may be used to drop delayed TCP segments and forward ACKs when wireless link errors (rather than network congestion) are causing the video player to experience impact to QoE. Large bursts of packet losses may likely be caused by network congestion, and therefore, may not be viable candidates for advancing the ACK because of a potential increased impact on the picture quality. In addition, smaller bursts of packet losses may be from wireless link losses and may be viable candidates for dropping the delayed TCP segments and sending the ACK to advance the TCP segments beyond the holes corresponding to the packet losses.

If context adaptive decision block 604 determines that the received segment is in-order, as well as an absence of application context triggers or network context triggers, then conventional TCP operation may be performed, as depicted by a conventional TCP block 612. As depicted by a decision block 614 and a block 616, if context adaptive decision block 604 determines a context trigger condition and a decision threshold has been reached (e.g., the delayed TCP segment does not meet the delay threshold), then an out-of-order segment may be forwarded for further processing by skipping over the delayed TCP segment.

As previously discussed, delayed TCP segments exceeding the delay threshold (Δ) that also indicate a reduced priority level based on the application or network layer context information may be dropped. As a result, the plurality of TCP segments are delivered with a gap, wherein the gap corresponds to the missing bytes in the byte sequence that are contained in the delayed TCP segment. In addition, an acknowledgement (ACK) may be communicated to advance TCP segments beyond the gaps in a block 618. In other words, the ACK indicates that the TCP receiver expects to receive a TCP segment that logically follows the delayed TCP segment. Thus, the TCP receiver may relax the conditions on reliable delivery of information by allowing for selective issuance of fake ACKs for defined TCP segments that are determined to be of lower priority based on the application layer information and network layer information. Therefore, once the delay threshold (Δ) is reached, context adaptive decision block 604 may release outstanding TCP segments and the TCP receiver may proceed with the ACK of the next TCP segment.

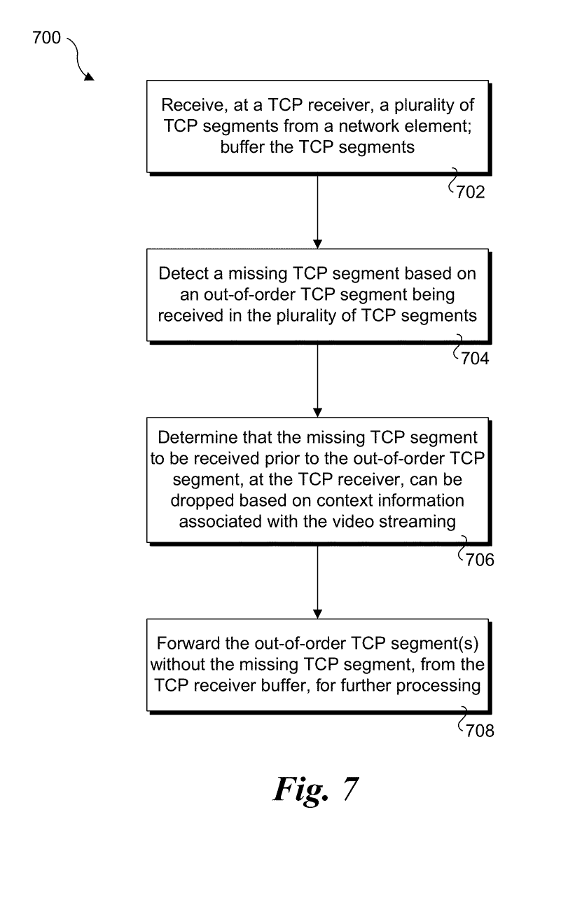

FIG. 7 shows a flowchart 700 illustrating operations performed by system 600 to selectively forward portion of a received bitstream with a missing TCP segment, accordingly to one embodiment. In a block 702 a plurality of TCP segments are received by a TCP receiver and buffer in a TCP receiver buffer. In a block 704, a missing TCP segment is detected to be missing based on an out-of-order TCP segment being received among the plurality of received TCP segments. In a block 706, a determination is made that the missing TCP segment can be dropped based on context information associated with the video streaming. Accordingly, the out-of-order TCP segments (the identified out-of-order TCP segments and following in-order TCP segments that have been received) are forwarded from the TCP receiver buffer for further processing, as shown in a block 708.

In one example, the missing TCP segment may be dropped based on the context information when the missing TCP segment is not received within a predetermined time threshold. In one configuration, the context information includes network layer context information and application layer context information. In one example, the network layer context information can include at least one of: MAC layer packet loss, TCP receiver buffer content analysis, or network congestion information. In addition, the application layer context information can include at least one of: buffer status, frame type, saliency of video frames, type of video content, or other context such as device context information, or user context information.

In one configuration, the computer circuitry can be further configured to send a fake ACK message to the network element, based on the context information, falsely acknowledging that the missing TCP segment was received at the TCP receiver. In one example, the fake ACK message includes a request for the TCP segments that logically follow the out-of-order TCP segment to be transmitted to the TCP receiver.

In one configuration, the TCP receiver may be further configured to send an acknowledgement message to the TCP sender requesting that the missing TCP segment be retransmitted to the TCP receiver, wherein the missing TCP segment cannot be dropped based on the context information. In addition, the TCP receiver can be further configured to drop the missing TCP segment when the context information indicates that a wireless link error caused the out-of-order TCP segment to be delivered out-of-order. Furthermore, the TCP receiver can be further configured to determine that the missing TCP segment should not be dropped when the context information indicates that network congestion caused the out-of-order TCP segment to be delivered out-of-order to the TCP receiver buffer.

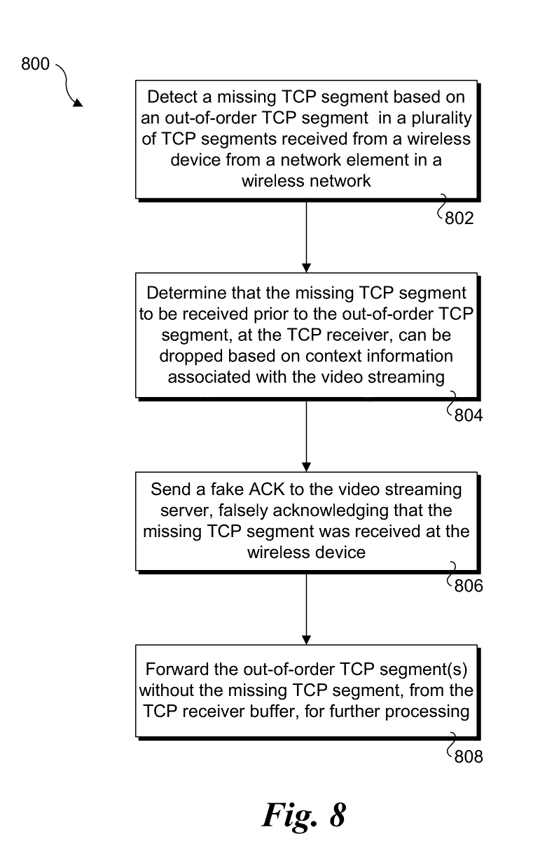

FIG. 8 shows a flowchart 800 illustrating operations performed at a TCP receiver associated with a wireless device in response to detecting a missing TCP segment was not received. In a block 802, a missing TCP segment is detected from among a plurality of TCP segments received at the wireless device from a network element in a wireless network. For example, the network element for a mobile wireless network will be a base station. In a block 804, a determination is made that the missing TCP segment can be dropped based on context information associated with the video streaming. In a block 806 a fake ACK is returned to the video streaming server (the TCP sender), falsely acknowledging that the missing TCP segment was received at the wireless device. The out-of-order TCP segments (the identified out-of-order TCP segments and following in-order TCP segments that have been received) are forwarded from the TCP receiver buffer for further processing, as shown in a block 808.

Generally, video streaming services offered by providers such as Netflix, Amazon, iTunes, YouTube, Hulu, etc., are facilitate through use of a large array of servers in data centers and the like. The servers are generally configured as “blade” servers comprising multiple server blades in a chassis or multiple server modules in a chassis. Multiple chassis are installed in server racks, and then multiple racks are interconnected in the data center to other racks using wire and/or optical cabling. In addition, storage arrays may be provided within a given rack or may be in separate racks from the servers. Generally, a rack of servers may include communication links (via the wired and/or optical cabling) to storage arrays and servers in other racks using switching elements such as Top of Rack (ToR) switches or through use of multiple switch blades or the like. Typically, communication between servers is facilitated over Ethernet links, while communication between servers and storage may employ Ethernet links or other protocols, such as InfiniBand links.

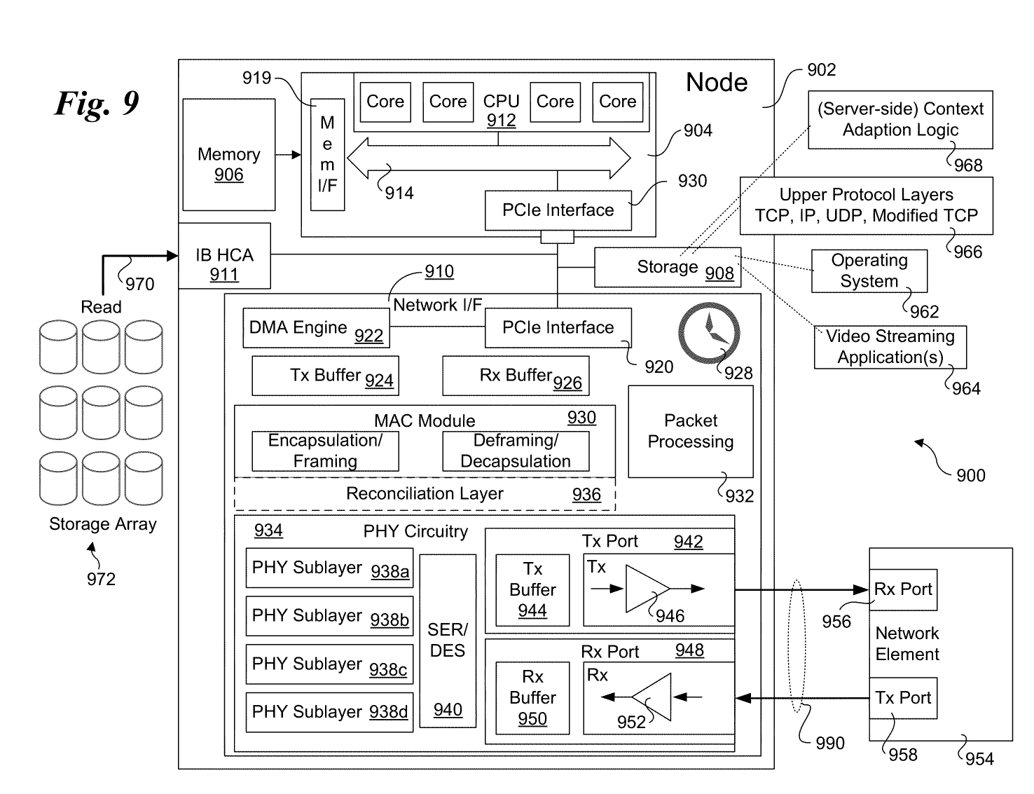

FIG. 9 is a block schematic diagram of an exemplary server node 900 that may be used to implement aspects of the video streaming server embodiments disclosed herein. In one embodiment, node 900 comprises a server blade or server module configured to be installed in a server chassis. The server blade/module includes a main board 902 on which various components are mounted, including a processor 904, memory 906, storage 908, a network interface 910, and an InfiniBand Host Channel Adapter (IB HCA) 911. Main board 902 will generally include one or more connectors for receiving power from the server chassis and for communicating with other components in the chassis. For example, a common blade server or module architecture employs a backplane or the like including multiple connectors in which mating connectors of respective server blades or modules are installed.

Processor 904 includes a CPU 912 including one or more cores. The CPU and/or cores are coupled to an interconnect 914, which is illustrative of one or more interconnects implemented in the processor (and for simplicity is shown as a single interconnect). Interconnect 914 is also coupled to a memory interface (I/F) 916 and a PCIe (Peripheral Component Interconnect Express) interface 918. Memory interface 916 is coupled to memory 906, while PCIe interface 918 provides an interface for coupling processor 904 to various Input/Output (I/O) devices, including storage 908, network interface 910, and IB HCA 911. Generally, storage 908 is illustrative of one or more non-volatile storage devices such as but not limited to a magnetic or optical disk drive, a solid state drive (SSD), a flash memory chip or module, etc.

Network interface 910 is illustrative of various types of network interfaces that might be implemented in a server end-node, such as an Ethernet network adaptor or NIC. Network interface 910 includes a PCIe interface 920, a Direct Memory Access (DMA) engine 922, a transmit buffer 924, a receive buffer 926, and real-time clock 928, a MAC module 930, and a packet processing block 932. Network interface 910 further includes PHY circuitry 934 comprising circuitry and logic for implementing an Ethernet physical layer. Also depicted is an optional reconciliation layer 936.

PHY circuitry 934 includes a set of PHY sublayers 938a-d, a serializer/deserializer (SERDES) 940, a transmit port 942 including a transmit buffer 944 and one or more transmitters 946, and a receive port 948 including a receive buffer 950 and one or more receivers 952. Node 900 is further illustrated as being linked in communication with a network element 954 including a receive port 956 and a transmit port 958 via a wired or optical link 960. Depending on the particular Ethernet PHY that is implemented, different combinations of PHY sublayers may employed, as well as different transmitter and receiver configurations. For example, a 10 GE (Gigabit Ethernet) PHY will employ different PHY circuitry that a 40 GE or a 100 GE PHY.

Various software components are executed on one or more cores of CPU 912 to implement software-based aspects of the video streaming server embodiments described and illustrated herein. Exemplary software components depicted in FIG. 9 include a host operating system 962, one or more video streaming applications 964, upper protocol layer software 966 (e.g., TCP, IP, UDP, modified TCP, and software instructions for implementing server-side context adaption logic 968. All or a portion of the software components generally will be stored on-board the server node, as depicted by storage 908. In addition, under some embodiments one or more of the components may be downloaded over a network and loaded into memory 906 and/or storage 908.

During operation of node 900, portions of host operating system 962 will be loaded in memory 906, along with one or more video streaming applications 964 that are executed in OS user space. Upper protocol layer software 966 generally may be implemented using an OS driver or the like, or may be implemented as a software component executed in OS user space. In some embodiments, upper protocol layer software 966 may be implemented in a virtual NIC implemented through use of virtualization software, such as a Virtual Machine Monitor (VMM) or hypervisor.

In the embodiment illustrated in FIG. 9, MAC module 930 is depicted as part of network interface 910, which comprises a hardware component. Logic for implementing various operations supported by network interface 910 may be implemented via embedded logic and/or embedded software. As an example, embedded logic may be employed for preparing upper layer packets for transfer outbound from transmit port 942. This includes encapsulation of packets in Ethernet packets, and then framing of the Ethernet packets, wherein Ethernet packets are used to generate a stream of Ethernet frames. In connection with these outbound (transmit) operations, real-time clock 928 is accessed (e.g., read) and a corresponding TCP retransmit timer timestamp is stored for each TCP segment that is transmitted, in accordance with conventional TCP operations.

On the receive side, a reversal of the foregoing transmit operations is performed. As data signals conveying Ethernet frames are received, they are processed by PHY circuitry 934 to regenerate an Ethernet frame stream (originally generated from a source end-node sending traffic to node 900), whereupon the Ethernet frames are deframed, to yield Ethernet packets, that are then de-capsulated to extract the higher layer protocol non-TCP packets.

Generally, packet processing block 930 may be implemented via embedded logic and/or embedded software. Packet processing block is implemented to manage forwarding of data within network interface 910 and also between network interface 910 and memory 906. This includes use of DMA engine 922 which is configured to forward data from receive buffer 926 to memory 906 using DMA writes, resulting in data being forwarded via PCIe interfaces 920 and 918 to memory 906 in a manner that doesn't involve CPU 912. In some embodiments, transmit buffer 924 and receive buffer 926 comprises Memory-Mapped IO (MMIO) address space that is configured to facilitate DMA data transfers between these buffers and memory 906 using techniques well-known in the networking art.

IB HCA 911 is coupled via an IB link 970 to storage array 972, which is used to store original video content in applicable encoded formats, such as but not limited to the various video encoding formats discussed herein. During video streaming operations, the original video content is read from application storage devices in storage array 972. As another option, live or video-on-command content originating from a video head-end or the link may be received via another port on network interface 910 or via a separate network interface (both not shown).

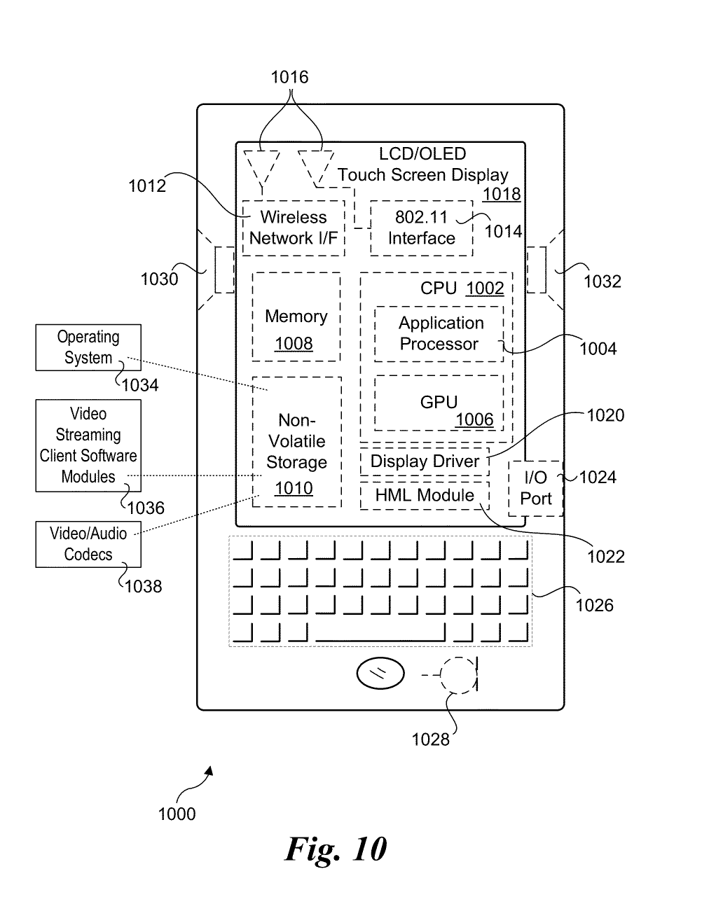

FIG. 10 shows mobile device 1000 that is illustrative of one embodiment of a video streaming client. Mobile device 1000 includes a processor 1002 comprising a central processing unit including an application processor 1004 and a graphics processing unit (GPU) 1006. Processor 1002 is operatively coupled to each of memory 1008, non-volatile storage 1010, a wireless network interface 1012 and an IEEE 802.11 wireless interface 1014, each of which is coupled to a respective antenna 1015 and 1016. Mobile device 1000 also includes a display screen 1018 comprising a liquid crystal display (LCD) screen, or other type of display screen such as an organic light emitting diode (OLED) display. Display screen 1018 may be configured as a touch screen though use of capacitive, resistive, or another type of touch screen technology. Mobile device 1000 further includes a display driver 1020, an HML (high-definition media link) module 1022, an I/O port 1024, a virtual or physical keyboard 1026, a microphone 1028, and a pair of speakers 1030 and 1032.

During operation, software instructions comprising an operating system 1034, video streaming client software modules 1036, and video/audio codecs 1038 are loaded from non-volatile storage 1010 into memory 1008 for execution on an applicable processing element on processor 1002. For example, these software components and modules, as well as other software instructions are stored in on-volatile storage 1010, which may comprises any type of non-volatile storage device, such as Flash memory. In one implementation, logic for implementing one or more video codecs may be embedded in GPU 1006 or otherwise comprise instructions that are executed, at least in part, by GPU 1006. Generally, video streaming client software modules comprises various software instructions for implementing aspects of the video streaming client embodiments described and illustrated herein. In addition to software instructions, a portion of the instructions for facilitating these and other operations may comprise firmware instructions that are stored in non-volatile storage 1010 or another non-volatile storage device (not shown).

More generally, mobile device is illustration of the wireless device, such as a user equipment (UE), a mobile station (MS), a mobile wireless device, a mobile communication device, a tablet, a handset, or other type of wireless device. The wireless device can include one or more antennas configured to communicate with a node, macro node, low power node (LPN), or, transmission station, such as a base station (BS), an evolved Node B (eNB), a baseband unit (BBU), a remote radio head (RRH), a remote radio equipment (RRE), a relay station (RS), a radio equipment (RE), or other type of wireless wide area network (WWAN) access point. The wireless device can be configured to communicate using at least one wireless communication standard including 3GPP LTE, WiMAX, High Speed Packet Access (HSPA), Bluetooth, and WiFi™. The wireless device can communicate using separate antennas for each wireless communication standard or shared antennas for multiple wireless communication standards. The wireless device can communicate in a wireless local area network (WLAN), a wireless personal area network (WPAN), and/or a WWAN.

Display driver 1020 is used to generate signals that drive generation of pixels on display screen 1018, enabling video content received via a video stream client application/player to be view as a sequence of video frames. HML module enables mobile device 1000 to be used as a playback device on an external display such as an HDTV coupled to an HML receiver via either a wireless link or a cable link that is connected through I/O port 1024. For example, I/O port 1024 may comprise a mini-USB port to which an HML dongle may be coupled. Optionally, mobile device 1000 may be able to generate wireless digital video signals to playback video content on a display coupled to a receiver configured to receive the video signals, such as an Apple TV device, a WiFi Direct receiver, or similar type of device.

In addition, mobile device 1000 is generally representative of both wired and wireless devices that are configured to implement the functionality of one or more of the video streaming client embodiments described and illustrated herein. For example, rather than one or more wireless interfaces, a video streaming client host device may have a wired or optical network interface, such as an Ethernet NIC or the like.

Various components illustrated in FIG. 10 may also be used to implement other types of video streaming clients, such as included in a Blu-ray player or a smart TV. In the case of a Blu-ray player, the video streaming client will generally include an HDMI interface and be configured to generate applicable HDMI signals to drive a display device connected via a wired or wireless HDMI link, such as an HDTV or computer monitor. Since smart TV's have built-in displays, they can directly playback video streaming content transported from a video streaming server.

Generally, multiple HTTP streaming connections may be received at a single physical wireless or wired network port/interface using well-known multiplexing techniques. Each streaming connection may employ a respective logical port implemented by the network port or interface. Optionally, multiple virtualized network ports may be implemented via software, wherein each virtual network port has its own address.

In addition to the use of two streaming connections illustrated in the embodiments herein, the principles and teachings of these embodiments may be extended to support three or more streaming connections, as well as other supporting other schemes for transferring video streaming content. For example, in one embodiment I-frames, P-frames, and B-frames are sent over respective streaming connections. In one embodiment, audio content is sent over a separate streaming connection from the video content. In addition to transferring I-frame content over a separate streaming connection, a combination of I-frame and P-frame content may be sent over the same streaming connection. Multiple streaming connections may also be used for SVC content, with one streaming connection being used for the base layer, and one or more other separate streaming connections used for multiple enhancement layers.

Further aspects of the subject matter described herein are set out in the following numbered clauses:

1. A method for streaming video content from a video streaming server to a video streaming client, comprising;

splitting video content into a plurality of encoded video bitstreams having at least two priority levels including a high priority bitstream and a low priority bitstream;

transmitting the plurality of encoded video bitstreams using a plurality of streaming connections, wherein the high priority bitstream is transmitted over a first streaming connection using a reliable transport mechanism, and wherein the low priority bitstream is transmitted using a second streaming connection under which content that is not successfully received may or may not be retransmitted;

reassembling the plurality of encoded video bitstreams that are received at the video streaming client into a reassembled encoded video bitstream; and

decoding the reassembled encoded video bitstream to playback the video content as a plurality of video frames.

2. The method of clause 1, wherein the first streaming connection employs an HTTP (Hypertext Transport Protocol) over TCP (transmission control protocol) streaming connection.

3. The method of clause 1 or 2, wherein the second streaming connection employs an HTTP (Hypertext Transport Protocol) over UDP (user datagram protocol) over streaming connection.

4. The method of any of the proceeding clauses, wherein the second streaming connection comprises an HTTP (Hypertext Transport Protocol) over a modified TCP (transmission control protocol) streaming connection under which an ACKnowledgement indicating each TCP segment is returned to the video streaming server whether or not the TCP segment is successfully received at the video streaming client.

5. The method of any of the proceeding clauses, further comprising:

reading encoded video content from one or more storage devices, the encoded video content including intra-frames (I-frames), predictive-frames (P-frames), and bi-directional frames (B-frames) encoded in an original order;

separating out the I-frame content to generate a high priority bitstream comprising the I-frame content and a low priority bitstream comprising the P-frame and B-frame content;

streaming the high priority bitstream and low-priority bitstreams in parallel over the first and second streaming connections; and

reassembling the I-frame, P-frame, and B-frame content in the high-priority and low-priority bitstreams such that the original encoded order of the I-frame, P-frame and B-frame content is restored.

6. The method of clause 5, wherein the encoded video content that is read from storage includes audio content, and the method further comprises:

extracting the audio content as an audio bitstream;

streaming the audio bitstream over the first streaming connection; and

adding the audio content to the reassembled video content.

7. The method of any of the proceeding clauses, further comprising:

splitting video content encoded using a scalable video coding (SVC) coder into a base layer bitstream and one or more enhancement layer bitstreams;

streaming the base layer bitstream over the first streaming connection;

streaming the one or more enhancement layer bitstreams over the second streaming connection; and

decoding the base layer bitstream and the one or more enhancement layer bitstreams at the video streaming client to playback the video content.

8. The method of any of the proceeding clauses, further comprising:

employing context information associated with at least one of the first and second streaming connections to manage transfer of video bitstream content over the that streaming connection.

9. The method of clause 8, wherein the context information includes network layer context information and application layer context information.

10. A non-transitory machine-readable medium having first software instructions comprising a video streaming server application and second software instructions comprising a video streaming client application stored thereon, wherein the first and second software instructions are configured to implement the method of any of the proceeding clauses when respectfully executed on a video streaming server and a video streaming client.

11. A video streaming server, comprising:

a processor;

memory; operatively coupled to the processor;

a network interface, operatively coupled to the processor;

a storage device, having instructions stored therein that are configured to be executed on the processor to cause the video streaming server to,

split video content into a plurality of encoded video bitstreams having at least two priority levels including a high priority bitstream and a low priority bitstream;

transmit the high priority bitstream from the network interface to a video streaming client over a first streaming connection between the video streaming server and the video streaming client employing a reliable transport mechanism; and

transmit the low priority bitstream from the network interface to the video streaming client over a second streaming connection between the video streaming server and the video streaming client.

12. A video streaming server of clause 11, wherein the first streaming connection employs an HTTP (Hypertext Transport Protocol) over TCP (transmission control protocol) streaming connection.

13. The video streaming server of clause 11 or 12, wherein the second streaming connection employs an HTTP (Hypertext Transport Protocol) over UDP (user datagram protocol) streaming connection.

14. The video streaming server of any of clauses 11-13, wherein the second streaming connection comprises an HTTP (Hypertext Transport Protocol) over a modified TCP (transmission control protocol) streaming connection under which an ACKnowledgement indicating each TCP segment is returned to the video streaming server whether or not the TCP segment is successfully received at the video streaming client.

15. The video streaming server of any of clauses 11-14, wherein the video streaming server further comprises an interface to access one or more storage devices, and wherein execution of the instructions further causes the video streaming server to:

read encoded video content from one or more storage devices, the encoded video content including intra-frames (I-frames), predictive-frames (P-frames), and bi-directional frames (B-frames) encoded in an original order;

separate out the I-frame content to generate a high priority bitstream comprising the I-frame content and a low priority bitstream comprising the P-frame and B-frame content; and

stream the high priority bitstream and low-priority bitstreams in parallel over the first and second streaming connections.

16. The video streaming server of clause 15, wherein the encoded video content that is read from the one or more storage devices includes audio content, and wherein execution of the instructions further causes the video streaming server to:

extract the audio content as an audio bitstream; and stream the audio bitstream over the first streaming connection.

17. The video streaming server of any of clauses 11-16, wherein execution of the instructions further causes the video streaming server to:

split video content encoded using a scalable video coding (SVC) coder into a base layer bitstream and one or more enhancement layer bitstreams;

stream the base layer bitstream over the first streaming connection; and

stream the one or more enhancement layer bitstreams over the second streaming connection.

18. The video streaming server of any of clauses 11-17, wherein execution of the instructions further causes the video streaming server to employ at least one of network layer context information and application layer context information associated with at least one of the first and second streaming connections to manage transfer of video bitstream content over the that streaming connection.

19. A video streaming client, comprising:

a processor;

memory, operatively coupled to the processor;

a display driver, operatively coupled to at least one of the processor and the memory;

a network interface, operatively coupled to the processor; and

a storage device, having instructions stored therein that are configured to be executed on the processor to cause the video streaming client to,

receive, at the network interface, a plurality of encoded video bitstreams streams from a video streaming server using a plurality of streaming connections, wherein the plurality of encoded video bitstreams are derived from original video content that has been split by the video streaming server into a plurality of encoded video bitstreams having at least two priority levels including a high priority bitstream and a low priority bitstream, and wherein the high priority bitstream is received over a first streaming connection and a low priority bitstream is received over a second streaming connection;

reassemble the plurality of encoded video bitstreams that are received at the network interface into a reassembled encoded video bitstream; and

decode the reassembled encoded video bitstream to playback the original video content via the display driver as signals representative of a plurality of video frames.

20. The video streaming client of clause 19, wherein the video streaming client comprises a wireless device having a wireless network interface and a display coupled to the display driver, wherein the plurality of encoded video bitstreams are received via the wireless network interface, and when the signals representative of the plurality of video frames are processed by the video streaming client to generate a sequence of video frames on the display.

21. The video streaming client of clause 19 or 20, wherein the first streaming connection employs an HTTP (Hypertext Transport Protocol) over TCP (transmission control protocol) streaming connection, and the second streaming connection employs one of:

an HTTP over UDP (user datagram protocol) streaming connection; or

an HTTP over a modified TCP streaming connection under which an ACKnowledgement indicating each TCP segment is returned to the video streaming server whether or not the TCP segment is successfully received at the video streaming client.

22. The video streaming client of any of clauses 19-21, wherein the origin video content comprises a plurality of frames including intra-frames (I-frames), predictive-frames (P-frames), and bi-directional frames (B-frames) encoded in an original order, and wherein execution of the instructions further causes the video streaming client to:

separate out the I-frame content to generate a high priority bitstream comprising the I-frame content and a low priority bitstream comprising the P-frame and B-frame content;

receive I-frame content via the first streaming connection;

receive P-frame and B-frame content via the second streaming connections; and

reassemble the I-frame, P-frame, and B-frame content into a recombined bitstream such that the original encoded order of the I-frame, P-frame and B-frame content is restored.

23. The video streaming client of clause 22, wherein the video streaming server further comprises an audio interface, wherein the encoded video content that is read from the one or more storage devices includes audio content, and wherein execution of the instructions further causes the video streaming client to:

receive the audio content via the first streaming connection;

extract the audio content as an audio bitstream; and

playback the audio content over the audio interface.

24. The video streaming client of any of clauses 19-23, wherein the original video content is encoded using a scalable video coding (SVC) coder into a base layer bitstream and one or more enhancement layer bitstreams, and wherein execution of the instructions further causes the video streaming client to:

receive the base layer bitstream over the first streaming connection;

split video content encoded using the SVC coder into a base layer bitstream and one or more enhancement layer bitstreams;

stream the base layer bitstream over the first streaming connection;

receive the one or more enhancement layer bitstreams over the second streaming connection; and

decode the base layer bitstream and the one or more enhancement layer bitstreams to playback the original video content via the display driver as signals representative of a plurality of video frames.

25. The video streaming client of any of clauses 19-24, wherein execution of the instructions further causes the video streaming client to employ at least one of network layer context information and application layer context information associated with at least one of the first and second streaming connections to manage transfer of video bitstream content over the that streaming connection.

26. The video streaming client of any of clauses 19-25, wherein one of the streaming connections employs TCP (transmission control protocol), and wherein execution of the instructions further causes the video streaming client to:

receive a plurality of TCP segments;

detect the plurality the TCP segments includes a missing TCP segment resulting in gap followed by an out-of-order TCP segment; and

determine the out-of-order TCP segment may be forwarded for further processing without the missing TCP segment.

27. A method performed by a video streaming server, comprising:

splitting video content into a plurality of encoded video bitstreams having at least two priority levels including a high priority bitstream and a low priority bitstream;

transmitting the high priority bitstream from the network interface to a video streaming client over a first streaming connection between the video streaming server and the video streaming client employing a reliable transport mechanism; and

transmitting the low priority bitstream from the network interface to the video streaming client over a second streaming connection between the video streaming server and the video streaming client.

28. The method of clause 27, wherein the first streaming connection employs an HTTP (Hypertext Transport Protocol) over TCP (transmission control protocol) streaming connection.

29. The method of clause 27 or 28, wherein the second streaming connection employs an HTTP (Hypertext Transport Protocol) over UDP (user datagram protocol) streaming connection.

30. The method of any of clauses 27-29, wherein the second streaming connection comprises an HTTP (Hypertext Transport Protocol) over a modified TCP (transmission control protocol) streaming connection under which an ACKnowledgement indicating each TCP segment is returned to the video streaming server whether or not the TCP segment is successfully received at the video streaming client.

31. The method of any of clauses 27-30, further comprising:

reading encoded video content from one or more storage devices, the encoded video content including intra-frames (I-frames), predictive-frames (P-frames), and bi-directional frames (B-frames) encoded in an original order;

separating out the I-frame content to generate a high priority bitstream comprising the I-frame content and a low priority bitstream comprising the P-frame and B-frame content; and

streaming the high priority bitstream and low-priority bitstreams over the first and second streaming connections.

32. The method of clause 31, wherein the encoded video content that is read from the one or more storage devices includes audio content, the method further comprising:

extracting the audio content as an audio bitstream; and

stream the audio bitstream over the first streaming connection.

33. The method of any of clauses 27-32, the method further comprising:

splitting video content encoded using a scalable video coding (SVC) coder into a base layer bitstream and one or more enhancement layer bitstreams;

streaming the base layer bitstream over the first streaming connection; and

streaming the one or more enhancement layer bitstreams over the second streaming connection.

34. The method any of clauses 27-33, further comprising employing at least one of network layer context information and application layer context information associated with at least one of the first and second streaming connections to manage transfer of video bitstream content over the that streaming connection.

35. A non-transitory machine-readable medium having software instructions stored thereon that are configured to implement the method of any of clauses 27-34 when executed on a video streaming server.

36. A video streaming server comprising means for implementing the method of any of clauses 27-34.

37. A method performed by a video streaming client, comprising:

receiving a plurality of encoded video bitstreams streams from a video streaming server using a plurality of streaming connections, wherein the plurality of encoded video bitstreams are derived from original video content that has been split by the video streaming server into a plurality of encoded video bitstreams having at least two priority levels including a high priority bitstream and a low priority bitstream, and wherein the high priority bitstream is received over a first streaming connection and a low priority bitstream is received over a second streaming connection;

reassembling the plurality of encoded video bitstreams that are received at the network interface into a reassembled encoded video bitstream; and

decoding the reassembled encoded video bitstream to playback the original video content as signals representative of a plurality of video frames.

38. The method of clause 37, wherein the video streaming client comprises a wireless device having a wireless network interface and a display coupled to a display driver, wherein the plurality of encoded video bitstreams are received via the wireless network interface, and when the signals representative of the plurality of video frames are processed by the video streaming client to generate a sequence of video frames on the display.

39. The method of clause 37 or 38, wherein the first streaming connection employs an HTTP (Hypertext Transport Protocol) over TCP (transmission control protocol) streaming connection, and the second streaming connection employs one of:

an HTTP over UDP (user datagram protocol) streaming connection; or

an HTTP over a modified TCP streaming connection under which an ACKnowledgement indicating each TCP segment is returned to the video streaming server whether or not the TCP segment is successfully received at the video streaming client.

40. The method of any of clauses 37-39, wherein the origin video content comprises a plurality of frames including intra-frames (I-frames), predictive-frames (P-frames), and bi-directional frames (B-frames) encoded in an original order, the method further comprising:

separating out the I-frame content to generate a high priority bitstream comprising the I-frame content and a low priority bitstream comprising the P-frame and B-frame content;

receiving I-frame content via the first streaming connection;

receiving P-frame and B-frame content via the second streaming connections; and

reassembling the I-frame, P-frame, and B-frame content into a recombined bitstream such that the original encoded order of the I-frame, P-frame and B-frame content is restored.

41. The method of clause 40, wherein the video streaming server further comprises an audio interface, wherein the encoded video content that is read from the one or more storage devices includes audio content, and wherein execution of the instructions further causes the video streaming client to:

receive the audio content via the first streaming connection;

extract the audio content as an audio bitstream; and

playback the audio content over the audio interface.

42. The method of any of clauses 37-41, wherein the original video content is encoded using a scalable video coding (SVC) coder into a base layer bitstream and one or more enhancement layer bitstreams, the method further comprising:

receiving the base layer bitstream over the first streaming connection;

splitting video content encoded using a scalable video coding (SVC) coder into a base layer bitstream and one or more enhancement layer bitstreams;

streaming the base layer bitstream over the first streaming connection;

receiving the one or more enhancement layer bitstreams over the second streaming connection; and

decoding the base layer bitstream and the one or more enhancement layer bitstreams to playback the original video content via the display driver as signals representative of a plurality of video frames.

43. The method of any of clauses 37-42, further comprising employing at least one of network layer context information and application layer context information associated with at least one of the first and second streaming connections to manage transfer of video bitstream content over the that streaming connection.

44. The method of any of clauses 37-43, wherein one of the streaming connections employs TCP (transmission control protocol), the method further comprising:

receiving a plurality of TCP segments;

detecting the plurality the TCP segments includes a missing TCP segment resulting in gap followed by an out-of-order TCP segment; and

determining the out-of-order TCP segment may be forwarded for further processing without the missing TCP segment.

45. A non-transitory machine-readable medium having software instructions stored thereon that are configured to implement the method of any of clauses 37-44 when executed on a video streaming client device.

46. A video streaming client comprising means for implementing the method of any of clauses 37-44.

Although some embodiments have been described in reference to particular implementations, other implementations are possible according to some embodiments. Additionally, the arrangement and/or order of elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

In the description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

An embodiment is an implementation or example of the inventions. Reference in the specification to “an embodiment,” “one embodiment,” “some embodiments,” or “other embodiments” means that a particular feature, structure, or characteristic described in connection with the embodiments is included in at least some embodiments, but not necessarily all embodiments, of the inventions. The various appearances “an embodiment,” “one embodiment,” or “some embodiments” are not necessarily all referring to the same embodiments.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

As discussed above, various aspects of the embodiments herein may be facilitated by corresponding software and/or firmware components and applications, such as software running on a server or device processor or software and/or firmware executed by an embedded processor or the like. Thus, embodiments of this invention may be used as or to support a software program, software modules, firmware, and/or distributed software executed upon some form of processing core (such as the CPU of a computer, one or more cores of a multi-core processor), a virtual machine running on a processor or core or otherwise implemented or realized upon or within a computer-readable or machine-readable non-transitory storage medium. A computer-readable or machine-readable non-transitory storage medium includes any mechanism for storing or transmitting information in a form readable by a machine (e.g., a computer). For example, a computer-readable or machine-readable non-transitory storage medium includes any mechanism that provides (i.e., stores and/or transmits) information in a form accessible by a computer or computing machine (e.g., computing device, electronic system, etc.), such as recordable/non-recordable media (e.g., read only memory (ROM), random access memory (RAM), magnetic disk storage media, optical storage media, flash memory devices, etc.). The content may be directly executable (“object” or “executable” form), source code, or difference code (“delta” or “patch” code). A computer-readable or machine-readable non-transitory storage medium may also include a storage or database from which content can be downloaded. The computer-readable or machine-readable non-transitory storage medium may also include a device or product having content stored thereon at a time of sale or delivery. Thus, delivering a device with stored content, or offering content for download over a communication medium may be understood as providing an article of manufacture comprising a computer-readable or machine-readable non-transitory storage medium with such content described herein.

Various components referred to above as processes, servers, or tools described herein may be a means for performing the functions described. The operations and functions performed by various components described herein may be implemented by software running on a processing element, via embedded hardware or the like, or any combination of hardware and software. Such components may be implemented as software modules, hardware modules, special-purpose hardware (e.g., application specific hardware, ASICs, DSPs, etc.), embedded controllers, hardwired circuitry, hardware logic, etc. Software content (e.g., data, instructions, configuration information, etc.) may be provided via an article of manufacture including computer-readable or machine-readable non-transitory storage medium, which provides content that represents instructions that can be executed. The content may result in a computer performing various functions/operations described herein.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the drawings. Rather, the scope of the invention is to be determined entirely by the following claims, which are to be construed in accordance with established doctrines of claim interpretation.

What is claimed is:

1. A method for streaming video content from a video streaming server to a video streaming client, comprising;
splitting video content into a plurality of encoded video bitstreams having at least two priority levels including a high priority bitstream and a low priority bitstream;
transmitting the plurality of encoded video bitstreams using a plurality of streaming connections, wherein the high priority bitstream is transmitted over a first streaming connection using a reliable transport mechanism, and wherein the low priority bitstream is transmitted using a second streaming connection under which content that is not successfully received may or may not be retransmitted;
reassembling the plurality of encoded video bitstreams that are received at the video streaming client into a reassembled encoded video bitstream; and
decoding the reassembled encoded video bitstream to playback the video content as a plurality of video frames.

2. The method of claim 1, wherein the first streaming connection employs an HTTP (Hypertext Transport Protocol) over TCP (transmission control protocol) streaming connection.

3. The method of claim 1, wherein the second streaming connection employs an HTTP (Hypertext Transport Protocol) over UDP (user datagram protocol) over streaming connection.

4. The method of claim 1, wherein the second streaming connection comprises an HTTP (Hypertext Transport Protocol) over a modified TCP (transmission control protocol) streaming connection under which an ACKnowledgement indicating each TCP segment is returned to the video streaming server whether or not the TCP segment is successfully received at the video streaming client.

5. The method of claim 1, further comprising:
reading encoded video content from one or more storage devices, the encoded video content including intra-frames (I-frames), predictive-frames (P-frames), and bi-directional frames (B-frames) encoded in an original order;
separating out the I-frame content to generate a high priority bitstream comprising the I-frame content and a low priority bitstream comprising the P-frame and B-frame content;
streaming the high priority bitstream and low-priority bitstreams in parallel over the first and second streaming connections; and
reassembling the I-frame, P-frame, and B-frame content in the high-priority and low-priority bitstreams such that the original encoded order of the I-frame, P-frame and B-frame content is restored.

6. The method of claim 5, wherein the encoded video content that is read from storage includes audio content, and the method further comprises:
extracting the audio content as an audio bitstream;
streaming the audio bitstream over the first streaming connection; and
adding the audio content to the reassembled video content.

7. The method of claim 1, further comprising:
splitting video content encoded using a scalable video coding (SVC) coder into a base layer bitstream and one or more enhancement layer bitstreams;
streaming the base layer bitstream over the first streaming connection;
streaming the one or more enhancement layer bitstreams over the second streaming connection; and
decoding the base layer bitstream and the one or more enhancement layer bitstreams at the video streaming client to playback the video content.

8. The method of claim 1, further comprising:
employing context information associated with at least one of the first and second streaming connections to manage transfer of video bitstream content over that streaming connection.

9. The method of claim 8, wherein the context information includes network layer context information and application layer context information.

10. A video streaming server, comprising:
a processor;
memory; operatively coupled to the processor;
a network interface, operatively coupled to the processor;
a storage device, having instructions stored therein that are configured to be executed on the processor to cause the video streaming server to,
split video content into a plurality of encoded video bitstreams having at least two priority levels including a high priority bitstream and a low priority bitstream;
transmit the high priority bitstream from the network interface to a video streaming client over a first streaming connection between the video streaming server and the video streaming client employing a reliable transport mechanism; and
transmit the low priority bitstream from the network interface to the video streaming client over a second streaming connection between the video streaming server and the video streaming client.

11. The video streaming server of claim 10, wherein the first streaming connection employs an HTTP (Hypertext Transport Protocol) over TCP (transmission control protocol) streaming connection.

12. The video streaming server of claim 10, wherein the second streaming connection employs an HTTP (Hypertext Transport Protocol) over UDP (user datagram protocol) streaming connection.

13. The video streaming server of claim 10, wherein the second streaming connection comprises an HTTP (Hypertext Transport Protocol) over a modified TCP (transmission control protocol) streaming connection under which an ACKnowledgement indicating each TCP segment is returned to the video streaming server whether or not the TCP segment is successfully received at the video streaming client.

14. The video streaming server of claim 10, wherein the video streaming server further comprises an interface to access one or more storage devices, and wherein execution of the instructions further causes the video streaming server to:
read encoded video content from one or more storage devices, the encoded video content including intra-frames (I-frames), predictive-frames (P-frames), and bi-directional frames (B-frames) encoded in an original order;
separate out the I-frame content to generate a high priority bitstream comprising the I-frame content and a low priority bitstream comprising the P-frame and B-frame content; and
stream the high priority bitstream and low-priority bitstreams in parallel over the first and second streaming connections.

15. The video streaming server of claim 14, wherein the encoded video content that is read from the one or more storage devices includes audio content, and wherein execution of the instructions further causes the video streaming server to:
extract the audio content as an audio bitstream; and
stream the audio bitstream over the first streaming connection.

16. The video streaming server of claim 10, wherein execution of the instructions further causes the video streaming server to:
split video content encoded using a scalable video coding (SVC) coder into a base layer bitstream and one or more enhancement layer bitstreams;
stream the base layer bitstream over the first streaming connection; and
stream the one or more enhancement layer bitstreams over the second streaming connection.

17. The video streaming server of claim 10, wherein execution of the instructions further causes the video streaming server to employ at least one of network layer context information and application layer context information associated with at least one of the first and second streaming connections to manage transfer of video bitstream content over the that streaming connection.

18. A video streaming client, comprising:
a processor;
memory, operatively coupled to the processor;
a display driver, operatively coupled to at least one of the processor and the memory;
a network interface, operatively coupled to the processor; and
a storage device, having instructions stored therein that are configured to be executed on the processor to cause the video streaming client to,
receive, at the network interface, a plurality of encoded video bitstreams streams from a video streaming server using a plurality of streaming connections, wherein the plurality of encoded video bitstreams are derived from original video content that has been split by the video streaming server into a plurality of encoded video bitstreams having at least two priority levels including a high priority bitstream and a low priority bitstream, and wherein the high priority bitstream is received over a first streaming connection and a low priority bitstream is received over a second streaming connection;
reassemble the plurality of encoded video bitstreams that are received at the network interface into a reassembled encoded video bitstream; and
decode the reassembled encoded video bitstream to playback the original video content via the display driver as signals representative of a plurality of video frames.

19. The video streaming client of claim 18, wherein the video streaming client comprises a wireless device having a wireless network interface and a display coupled to the display driver, wherein the plurality of encoded video bitstreams are received via the wireless network interface, and when the signals representative of the plurality of video frames are processed by the video streaming client to generate a sequence of video frames on the display.

20. The video streaming client of claim 18, wherein the first streaming connection employs an HTTP (Hypertext Transport Protocol) over TCP (transmission control protocol) streaming connection, and the second streaming connection employs one of:
an HTTP over UDP (user datagram protocol) streaming connection; or
an HTTP over a modified TCP streaming connection under which an ACKnowledgement indicating each TCP segment is returned to the video streaming server whether or not the TCP segment is successfully received at the video streaming client.

21. The video streaming client of claim 18, wherein the origin video content comprises a plurality of frames including intra-frames (I-frames), predictive-frames (P-frames), and bi-directional frames (B-frames) encoded in an original order, and wherein execution of the instructions further causes the video streaming client to:
separate out the I-frame content to generate a high priority bitstream comprising the I-frame content and a low priority bitstream comprising the P-frame and B-frame content;
receive I-frame content via the first streaming connection;
receive P-frame and B-frame content via the second streaming connections; and
reassemble the I-frame, P-frame, and B-frame content into a recombined bitstream such that the original encoded order of the I-frame, P-frame and B-frame content is restored.

22. The video streaming client of claim 21, wherein the video streaming server further comprises an audio interface, wherein the encoded video content that is read from the one or more storage devices includes audio content, and wherein execution of the instructions further causes the video streaming client to:
receive the audio content via the first streaming connection;
extract the audio content as an audio bitstream; and
playback the audio content over the audio interface.

23. The video streaming client of claim 18, wherein the original video content is encoded using a scalable video coding (SVC) coder into a base layer bitstream and one or more enhancement layer bitstreams, and wherein execution of the instructions further causes the video streaming client to:
receive the base layer bitstream over the first streaming connection;
split video content encoded using the SVC coder into a base layer bitstream and one or more enhancement layer bitstreams;
stream the base layer bitstream over the first streaming connection;
receive the one or more enhancement layer bitstreams over the second streaming connection; and
decode the base layer bitstream and the one or more enhancement layer bitstreams to playback the original video content via the display driver as signals representative of a plurality of video frames.

24. The video streaming client of claim 18, wherein execution of the instructions further causes the video streaming client to employ at least one of network layer context information and application layer context information associated with at least one of the first and second streaming connections to manage transfer of video bitstream content over the that streaming connection.

25. The video streaming client of claim 18, wherein one of the streaming connections employs TCP (transmission control protocol), and wherein execution of the instructions further causes the video streaming client to:
receive a plurality of TCP segments;
detect the plurality the TCP segments includes a missing TCP segment resulting in gap followed by an out-of-order TCP segment; and
determine the out-of-order TCP segment may be forwarded for further processing without the missing TCP segment.
